(19) United States
(12) Patent Application Publication
(10) Pub. No.: US 2012/0320298 A1
(43) Pub. Date: Dec. 20, 2012

(54) ELECTRO-OPTICAL SWITCHING ELEMENT AND ELECTRO-OPTICAL DISPLAY

(75) Inventors: Masayoshi Suzuki, Tokyo (JP); Naoya Fujiwara, Yokohama (JP)

(73) Assignee: Merck Patent Gesellschaft Mit Beschrankter Haftung, Darmstadt (DE)

(21) Appl. No.: 13/582,076

(22) PCT Filed: Feb. 11, 2011
(86) PCT No.: PCT/EP2011/000644

§ 371 Date: Aug. 31, 2012

(30) Foreign Application Priority Data
Mar. 1, 2010 (GB) 1003396.7

(51) Int. Cl. G02F 1/1335; G02F 1/1362; G02F 1/13357

(52) U.S. Cl. 349/43; 349/193; 349/62

(57) ABSTRACT

The instant invention relates electro-optical switching elements and displays comprising them. In particular, it relates to electro-optical switching elements comprising cholesteric liquid crystal layers, in particular, with both-handed twist senses, which selectively reflect visible light and/or light emitting moieties which are embedded in the cholesteric liquid crystal layers or other layers and an light controlling element that controls the amount of transmitted and/or reflected light. The displays give bright images under either bright or dark conditions with small power consumption. They are particularly suitable for e-paper applications and/or digital signage applications.

### FIELD OF THE INVENTION

The present invention relates to electro-optical switching elements and their use in electro-optical displays, as well as to these displays. In particular, the present invention relates to electro-optical switching elements leading to bright images with excellent visibility under bright ambient light conditions and hence with low power consumption and additionally featuring long term reliability. These electro-optical switching elements comprise at least one layer of a cholesteric liquid crystal, which optionally comprises a material, which in turn comprises one or more light emitting moieties. The electro-optical switching elements according to the present application are particularly well suited for so called electronic paper (e-paper) applications.

### State of the Art and Problems to be Solved

Electro-optical switching elements using a liquid crystal material with a helical structure, optionally comprising a fluorescent dye, as lighting and/or reflecting material with improved contrast by avoiding the otherwise typical strong selective reflection of ambient light by the liquid crystal helical structure are described in laid open Japanese patent application JP 2008-233915 (A).

Electro-optical switching elements using a liquid crystal material with a helical structure, optionally comprising a fluorescent dye, as a light conversion means capable to convert light (e.g. ambient light and/or light from a backlight system), each of said light conversion means
being capable to convert the state of polarization of the light from non-polarized light either to linear polarized light or to circular polarized light and, at the same time,
optionally is capable to shift the wavelength of the light to longer values is described in not yet laid open international patent application PCT/EP 2009/005866. They, however, use a liquid crystal cell comprising one or more polarizers, which leads to the device utilizing only half of the total light and/or to difficulties in utilizing a display effect having a memory effect.

In laid open Japanese patent application JP H08-286214 (A) (1996), a reflective liquid crystal display using guest-host type liquid crystals and a metal reflector is described.

In WO 2007/007384, a reflective liquid crystal display device in which stacked cholesteric liquid crystal layers, which change their selective reflections by application of a voltage is described.

Display devices using a cholesteric liquid crystal as the material controlling and modifying the propagation of light in reaction to an addressing voltage, i.e. as the switching medium, typically are exhibiting a memory effect and the images displayed are retained after the addressing voltage is turned off.

However, these types of electronic paper are not able to display clear images with good contrast and good readability even under dim ambient lighting conditions. The situation is even worse in case a colour filter is used in this type of displays. In this case, the images displayed are even poor under bright lighting conditions. The efficiency of the utilization of light by the displays is strongly reduced by the colour filter, which absorbs a large part of the incident light.

Besides these displays, in which liquid crystals are used as the switching medium, electrophoretic switching elements are e.g. known as “Quick Response Liquid Powder” or as displays in which bichromatic particles are used. These display devices typically also have a memory effect and images are maintained even after the addressing voltage is turned off. For example, in laid open Japanese patent application JP 2003-005225 (A) a display device in which charged particles are either collected and concentrated on an electrode having a small area or dispersed over an electrode having a large area. Thus, the device can be switched from a white state to a black state.

In WO2005/098525 a preferable size of such particles is described.

In laid open Japanese patent applications JP 2004-045643 (A) and JP 2007-206365 (A), a display device, in which small bichromatic spherical bodies. These tiny spheres are suspended/dispersed in a fluid and encased in a cell formed by a pair of substrates together with a frame. These spheres have two different semi-spheres each. One of these semi-spheres is black, whereas the other one is white. And at the same time, the two semi-spheres are electrically charged, having a charge of opposite sign to one another. Upon application of a voltage with the appropriate polarity to a pair of electrodes on the inner sides of the substrates an electrical field with a certain direction is created. Dependent on the orientation of the differently charged semi-spheres, the bichromatic spheres experience a torque and are rotated. Thus, by application of a voltage with the appropriate polarity the semi-spheres are made to alternatively present either their black semi-sphere or their white semi-sphere to an observer and, thus, black and white states may be displayed. The electro-optical effect of these displays is also called “electro-gyric” effect, from rotation induced by an electrical field.

In order to realize a colour image laid open Japanese patent application JP 2004-199022 (A) proposes to use three different types of bichromatic spheres, in which the semi-sphere of bichromatic spheres, which is not black, has one of three alternative, different colours, e.g. one of the three primary colours (red, green and blue), instead of white.

Alternatively, US 2002/0180688 (A) proposes the use of a colour filter on a respective black and white display.

These displays, however, are not able to display moving images, but their images are retained after switching off the driving voltage, which is advantageous for certain applications, in which power has to be conserved. They are frequently referred to as electronic paper (short e-paper) and are presently researched and developed extensively to replace common paper as display medium.

Also for the electro-gyric displays, in which the two-coloured semi-spheres having bipolar charges are used, the light utilizing efficiency is quite low. Here the cause is their efficiency of reflection is quite low, particularly for colour images due to the use of colour filters. They cannot give vivid images even under bright lighting conditions, either.

A reflective liquid crystal display, which is using no polarizer is described in SID 06 DIGEST, p. 769 to 772. Here a polymer dispersed liquid crystal (PDLC) display with a retro-reflector is described. In the state when the PDLC is transparent, the image is black and when the PDLC does scatter light, the image is white.

In this type of display the retro-reflector is desirable to be smaller than a pupil of the human eye. When the PDLC is transparent, among the light reflected by the retro-reflector only the part of the light that propagates in the direction to his pupil is visible for the observer. This means that there is practically no light that the observer sees and image appears black. However, when the PDLC is in the light scattering state, ambient light is reflected by the retro-reflector and is scattered by the PDLC. In this case also light, which has originally been coming from directions different from the direction to the pupil of the observer becomes visible and the image appears white.

However, the preparation of the retro-reflector used in these displays requires micro-lithographic steps with a high resolution and it is difficult scale it to the whole area of larger displays.

### PRESENT INVENTION

In the present invention one or more electro-optical switching elements, which are capable to alter the intensity of light, preferably to regulate or modify the intensity of light, i.e. control the intensity of light, in response to the application of an electrical voltage, are used. Said electro-optical switching elements are able to regulate the intensity of light, which is transmitted and/or reflected by the respective parts of a device. Said electro-optical switching elements according to the present invention do not require, and preferably do not comprise, a means to polarize light, e.g. a polarizer. Preferably the devices according to the present application do not comprise a means to polarize light or change the polarization of light and, most preferably, they do not comprise a polarizer.

Preferably the devices according to the present application are comprising one or more electro-optical elements capable of switching and/or controlling the degree of transmission/reflection/scattering of light.

Preferably the devices according to the present application are comprising one or more light reflection means capable to reflect light (e.g. ambient light), said light reflection means is capable to selectively reflect light of particular wavelength region.

Preferably the devices according to the present application are electronic displays. Particularly preferred they are displays for the display of information and most preferred they are displays for so called “electronic paper”.

Respective novel display devices, which utilize only reflected light, are advantageously used, as they achieve a significant reduction in the consumption of power.

The use of one or more electro-optical elements, which are capable of switching and/or controlling the degree of transmission/reflection/scattering of light, which allows the use of two different cholesteric layers at the same time in relation to one electro-optical element, i.e. in one electro-optical switching element. These two different layers of cholesteric liquid crystal preferably have a mutually opposite twisting sense (i.e. a mutually opposite handedness) with respect to one another.

In a preferred embodiment of the present invention the electro-optical devices according to the present invention have a unique combination and arrangement of optical elements so that they utilize reflected ambient light as well as the light from a backlight and hence, they lead to a bright image with clear visibility under bright ambient light conditions with low power consumption.

According to a preferred embodiment of the present invention, one or more optical elements are used, comprising
one or more light reflection means capable to reflect light (e.g. ambient light), said light reflection means
   is capable to selectively reflect light of particular wavelength region and, at the same time,
   optionally is capable to shift the wavelength of the light to longer values, preferably into visible light and
at least one of said conversion means
   is capable to shift the wavelength of the light to longer values and
a material, preferably in the form of a layer, which is capable of altering the intensity of light, preferably of regulating or modifying the intensity of light, i.e. switching and/or controlling, the intensity of light, preferably provided with one or more means of electrical addressing of said material,
preferably no means to polarize light, and
optionally a means for illumination, as e.g. a backlight.

The electro-optical devices according to the present invention comprise one or more optical elements arranged in such a way that they utilize the light from the backlight system quite efficiently and further that the radiation from the backlight system does not include radiation having a high energy, preferably it does not include any UV radiation and more preferably also no blue light with short wavelengths. Preferably the wavelength of the light is 385 nm or more, more preferably 420 nm or more and most preferably 435 nm or more.

The expression of the material being capable of altering the intensity of light means that the state of transmission through the material may be altered at least from one state to at least one other state by application of an external force, preferably by electrically addressing it. The change of the transmission may be, and preferably is, more or less continuous, in order to facilitate the representation of grey scales.

It is, however, also possible to use electro-optical switching elements using effects, which exhibit bistability. The latter case is often beneficially used in devices for applications, which require economising of the energy used, like e.g. in e-paper applications, which are preferred according to the present invention.

The light reflection means used according to the present application may have different forms. In a preferred embodiment they are comprising one or more layers, which are more or less flat, essentially continuous layers preferably covering essentially all switching elements of the display. In an other embodiment the reflection means preferably are structured, e.g. in a patterned way, such as e.g. being essentially congruent with the pixels or sub-pixels of a display, as will be explained in some detail below.

According to the present invention an optical element is realized, which comprises one or more layers of cholesteric liquid crystal, having at least one twisting sense or a cholesteric liquid crystal layer that contains at least one light emitting moiety as a reflector and has an optical component that controls light intensity. Since a cholesteric liquid crystal layer is an efficient light reflector, the reflection intensity is quite high. Colesteric liquid crystals with both right-handed and left-handed twist senses are available and hence, theoretically a reflection efficiency of 100% may be achieved. Further more, at least one of the cholesteric liquid crystal layers can contain light a material comprising one or more emitting moieties Then, clear and well readable images are displayed even under dark conditions by illuminating the cholesteric liquid crystal layers with an appropriate light source. The cholesteric liquid crystal layers can be easily coated on a substrate and can be fabricated easily since photo-polymerizable materials are available. The light emitting moiety or moieties can be present in a different layer from the cholesteric liquid crystal layer, preferably positioned on the side of the cholesteric liquid crystal layer facing an observer.

The cholesteric layer or layers preferably are s present in the form of a polymeric film or of polymeric films. They may beneficially be structured in the form of a matrix having areal parts matching the pixels of a display. These areal parts may conform to different colours in a patterned way. They further beneficially may consist of double layers having mutually opposite twisting sense to one another.

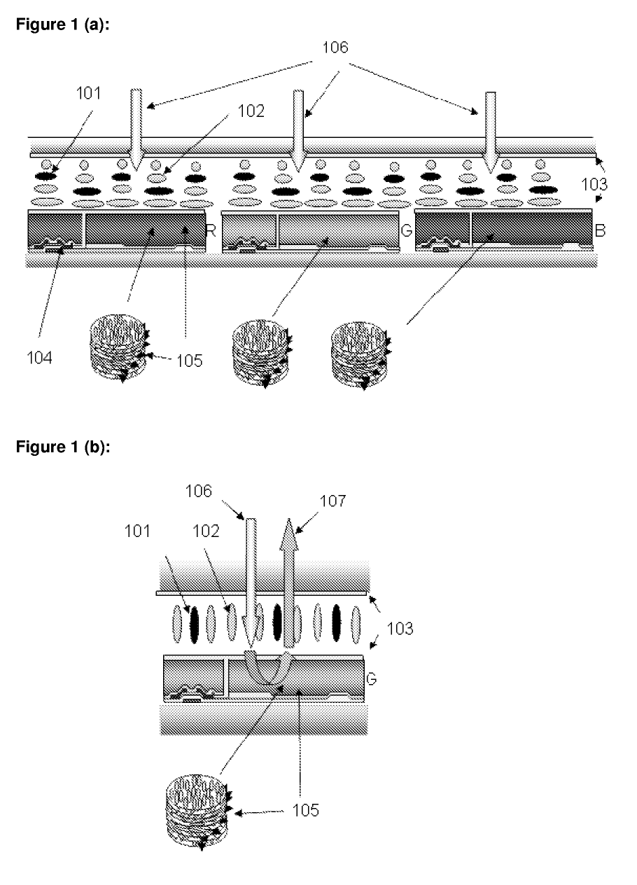

In the first preferred embodiment according to the instant invention, the optical element that controls the amount of light is a liquid crystal cell comprising a nematic liquid crystal, which is doped by one or more dichroic dye(s). In FIG. 1 the device is shown for the embodiment in which the twisted nematic LC structure is used. This structure may be applied either for liquid crystals in the twisted nematic structure or in the vertically aligned structure. In these two different possible structures the corresponding switching states are exchanged in case of a voltage applied versus the case when no voltage is applied. The twist angle is preferably 90° or approximately 90°. The liquid crystal comprises one or more dichroic dyes (101). The liquid crystal is called the “host” and the dichroic dye is called the “guest”. The dichroic dyes have their transition moment parallel to their long molecular axis, in this case, which is oriented parallel to the director of the host liquid crystal, i.e. the average of the long molecular axis of the liquid crystal. However, also dichroic dyes having their transition moment perpendicular to the average orientation of the long molecular axis i.e. the director of the liquid crystal host may be used. The liquid crystal host (102) shown in this figure has a positive dielectric anisotropy. However, also a liquid crystal host having a negative dielectric anisotropy may be beneficially used, in which case the addition of a chiral dopant to the host liquid crystal is optional only. The guest-host mixture consisting of the liquid crystal host and the dichroic dye, respectively the dicroic dyes, is filled in a liquid crystal cell which is composed of two substrates, at least one of which is a transparent substrate, and an appropriate frame. The two substrates each have a transparent electrode (103), respectively transparent electrodes on their inner sides, i.e. facing the liquid crystal. The electrodes preferably are covered with an alignment layer, preferably with a polyimide alignment layer. This is not shown in the figure. This part of the embodiment is similar to that of a conventional nematic liquid crystal cell. The liquid crystal may be beneficially addressed by an active matrix driving system e.g. using thin film transistors (TFTs: (104)), again like in the case of a conventional liquid crystal display. The liquid crystal may, however, also be either directly addressed or by a passive matrix driving system, i.e. in the so called “time multiplex” addressing. These two latter cases of addressing do not requires a matrix of active driving elements (e.g. TFTs). In an active matrix driving system, typically, and preferably, liquid crystal cells are used in which the director of the liquid crystal is twisted by an angle with an absolute value of 90° or of about 90° through the cell from the bottom substrate to the top substrate (“TN” configuration). In contrast, in displays using a passive matrix driving system, the director of the liquid crystal is twisted by an angle with an absolute value in the range of 180° to 270°, preferably in the range of 240° to or 270° (“STN” configuration).

The major difference of these electro-optical switching elements according to the present invention compared with conventional liquid crystal switching elements is that they comprise a layer of cholesteric liquid crystal (105) having a selective reflection in the range of visible light. This layer of cholesteric liquid crystal is preferably located between the lower substrate and the respective electrode of this substrate. To realise a colour display e.g. three of these switching elements may be conveniently used, each one having a different cholesteric liquid crystal exhibiting a different wavelength of selective reflection. Preferably one each of these different cholesteric liquid crystals has a region of wavelengths of selective reflection in a spectral region corresponding to one each of the three primary colours red (R), green (G) and blue (B), respectively.

FIG. 1a shows the schematical structure of the switching elements for a guest-host liquid crystal having a twist angle of 90° in case that a liquid crystal host mixture with a positive dielectric anisotropy is used and there is no voltage applied to the electrodes of the switching element. Then the director of the liquid crystal is oriented parallel to the substrates and twisted over an angle of 90° from the bottom substrate to the top substrate. In that state the ambient light (106), which enters the guest host liquid crystal is strongly absorbed by the dichroic dye, which has a strong absorption along its long molecular axis. And, consequently, the light does not reach the layer of the cholesteric liquid crystal. In this state the switching element (pixel) shows a dark image. In order to achieve a broad spectrum covering most or even all of the visible range of the spectrum a combination of more than one dichroic dye, preferably of three dichroic dyes, is used. These dyes are selected appropriately for their individual contributions to the spectrum.

FIG. 1b shows exemplarily for one switching element, the situation when a voltage of an appropriate magnitude (i.e. sufficiently above the threshold voltage) is applied to the electrodes sandwiching the guest host liquid crystal. Now the director of the liquid crystal is oriented perpendicular to the substrates and the dichroic dye (101) does no longer strongly absorb the ambient light. Then the incident light does reach the layer of the cholesteric liquid crystal (105) and the part of the incident light having the appropriate wavelength is selectively reflected. Since the selective reflection from the cholesteric liquid crystal layer (105) is relatively strong, a rather bright image is obtained. This holds even under dim lighting conditions, as the contrast of the image remains rather good. The regions of the wavelengths of selective reflection of the different cholesteric liquid crystals of the different switching elements may be selected to correspond to one each of the three primary colours and thus no colour filters are required for these displays. Furthermore, there is no need to use a polarizer, either.

In FIGS. 1a and 1b an embodiment having only a single layer of cholesteric liquid crystal is shown. However, in an alternative embodiment, a second layer of cholesteric liquid crystal having the sense of twist opposite to that of the first layer of cholesteric liquid crystal may additionally be used. The two layers may be stacked one on top of the other or, alternatively, they may be coated side by side. In the first case, when a stack of two layers is used, a particularly bright image may be realised because the stack of two layers of cholesteric liquid crystals does reflect circular polarized light of both senses of twist.

The light produced by the selective reflection from the cholesteric liquid crystals is characterised by a rather narrow angular distribution, leading to a rather strong angular dependence of the brightness of the light reflected. It may, however, be reduced by an intentional disturbation of the orientation of the axis of the layer of the cholesteric liquid crystals. This leads to an increased field of view as shown in Japanese laid open patent application JP 2005-003823 (A).

In the embodiment described above, a dichroic dye having a dichroic ratio of more than one (i.e. a dichroic dye having a stronger absorption parallel to its long molecular axis than perpendicular to its long molecular axis) is used in a liquid crystal host mixture with positive dielectric anisotropy. If either the dichroic dye or the liquid crystal used has the opposite anisotropy, (i.e. either the dichroic dye has a dichroic ratio of less than one or the liquid crystal host has a negative dielectric anisotropy) black and white images are reversed relative to the “on-state” and the “off-state” of the applied voltage. If both the dichroic dye and the liquid crystal host have the opposite anisotropy compared with the situation depicted in FIGS. 1a and 1b, only initial alignment of the liquid crystal has to be changed, but there is no change in the black and white states according to the applied voltage.

A light absorption layer may be beneficially placed between the cholesteric liquid crystal layer and the lower substrate and/or at the opposite side of the substrate to the cholesteric liquid crystal layer.

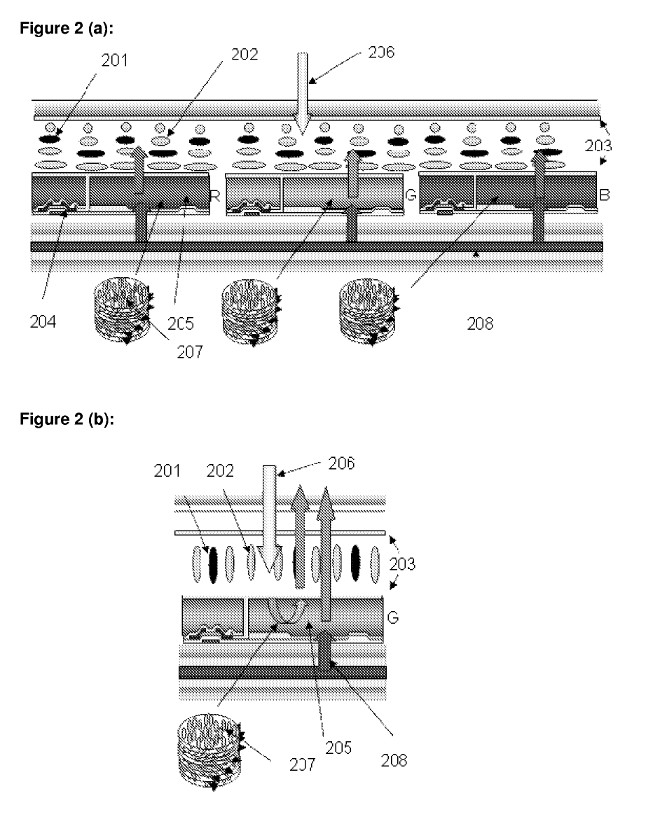

The structure of the display of the second preferred embodiment of the present invention is shown schematically in FIGS. 2a and 2b. It differs especially in two ways from the first embodiment, described above. Here the display comprise a light source (208) and the cholesteric liquid crystal layer(s) and/or layer(s) contain(s) additionally at least one material comprising one or more light emitting moieties (207). Here, the light emitting moiet(y)ies may be in the cholesteric liquid crystal layer or in another layer, which is not depicted in FIG. 2.

Said cholesteric liquid crystal layer(s) and/or another layer(s) containing additionally at least one material comprising one or more light emitting moieties are useful as light conversion means.

The light conversion means used according to the present invention may include one or more organic dyes and/or one or more inorganic phosphors.

As a material comprising one or more light emitting moieties (207) every material, which absorbs the light of the excitation and also emits light, may be used. Organic fluorescent dyes and/or inorganic phosphors can be used. When dyes with a small Stokes shift are used, ambient light can be used as the light for excitation. Brighter images may be obtained when a light source (208) is used for excitation, which emits blue light having a wavelength of 470 nm and/or, which emits light having wavelengths is shorter than 470 nm or, even more desirable, shorter than 400 nm. As light source for the excitation (208) inorganic light emitting diodes (LEDs), organic light emitting diodes (OLEDs) or fluorescent lamps or lasers may be used.

It is also possible to apply a method of locally dimming the back light in a respective displays in order to economize the use of energy. In such displays the backlight typically is segmented and, in principle, only the pixels displaying bright colour are irradiated with light from the respective segments of the segmented backlight providing the excitation light.

As organic dyes, various kinds of fluorescent dyes and phosphorescent dyes may be beneficially used, such as laser dyes and/or light emissive dyes used in organic light emitting diodes. Respective laser dyes are commercially available from Exciton Corporation, USA via Indeco Corporation, Japan, whereas other suitable dyes are commercially available from American Dye Sources Inc., Canada.

Laser dyes with an emission wavelength in the blue spectral region, which may be used here, are e.g. commercially available from Exciton Corporation, USA via Indeco Corporation, Japan e.g. Coumarin460, Coumarin480, Coumarin481, Coumarin485, Coumarin487, Coumarin490, LD489, LD490, Coumarin500, Coumarin503, Coumarin504, Coumarin504T and Coumarin515. Besides these laser dyes, fluorescent dyes with an emission in the blue spectral region such as perylene, 9-amino-acridine, 12(9-anthroyloxy)stearic acid, 4-phenylspiro[furan-2(3H), 1′-futalan]-3,3′-dione, N-(7-dimethylamino-4-methylcoumarynyl)-maleimide and/or the dyes ADS135BE, ADSO40BE, ADS256FS, ADS086BE, ADS084BE, which are commercially available from American Dye Sources Inc., Canada, may be used, too. These dyes may be used according to the present invention either individually or in the form of appropriate mixtures.

Laser dyes emitting in the green spectral region, which may be used here, are commercially available: e.g. Coumarin522, Coumarin 522B, Coumarin525 and Coumarin540A from Exciton Corporation, USA via Indeco Corporation, Japan and Coumarin 6, 8-hydroxy-xynoline* from Sigma-Aldrich^{Ltd}, Japan, a subsidiary of Sigma-Aldrich, USA. Besides these laser dyes, fluorescent dyes with an emission in the green spectral region such as the dyes ADS061 GE, ADS063GE, ADS108GE, ADS109GE and ADS128GE from American Dye Sources Inc., Canada, may be used, too. Also these dyes may be used according to the present invention either individually or in the form of appropriate mixtures.

Laser dyes emitting in the red spectral region, which may be used here, are commercially available: e.g. DCM, Fluorol 555, Rhodamine 560 Perchlorate, Rhodamine 560 Chloride and LDS698 from Exciton Corporation, USA via Indeco Corporation, Japan. Further, fluorescent dyes with an emission in the red spectral region such as ADS055RE, ADS061 RE, ADS068RE, ADS069RE and ADS076RE commercially available from American Dye Sources Inc., Canada, may be used. Also these dyes may be used according to the present invention either individually or in the form of appropriate mixtures.

Alternatively as organic dyes, dyes emitting light developed for organic light emitting diodes (OLEDs) may also be used here. Dyes, as those described in Japanese patent JP 2795932 (B2), which are able to convert colours, may be used according to the present invention. The dyes described in a paper S. A. Swanson et al., Chem. Mater., Vol. 15, (2003) pp. 2305-2312 may also be used beneficially. Blue dyes, as well as green dyes, as well as red as described in Japanese patent applications JP 2004-263179 (A), JP 2006-269819 (A) and JP 2008-091282 (A) may also be used In particular, for red dyes, green light emitting dyes, which convert UV radiation or blue light, may be used in combination with dyes emitting red light, which absorb green light and emit red light as described in laid open Japanese patent application JP 2003-264081 (A). These dyes most generally may be used as they are described by the respective references. However, it may be necessary to slightly modify their chemical structures by well known measures, for example by the introduction of alkyl chains or the modification of alkyl chains, to increase their solubility in organic solvents, and especially in liquid crystals.

As blue inorganic phosphors, Cu activated zinc sulfide phosphors as described in laid open Japanese patent application JP 2002-062530 (A) and/or Eu activated halophosphate phosphors, Eu activated aluminate phosphors as described in laid open Japanese patent application JP 2006-299207 (A) may be used. For green inorganic phosphors, Ce or Tb activated rare earth element borate phosphors as described in laid open Japanese patent application JP 2006-299207 (A) may be used. For red emission, Eu activated lanthanum sulfide phosphors or Eu activated yttrium sulfide phosphors as described in laid open Japanese patent application JP 2006-299207 (A) may be used. Yellow phosphors which consist of BaS and Cu²⁺ as a colour centre, as described in laid open Japanese patent application JP2007-063365 (A), and red phosphors which consist of Ba₂ZnS₃ and Mn²⁺ as a colour centre, as described in laid open Japanese patent application JP 2007-063366 (A), can also be used. Ce activated garnet phosphors, as described in Japanese patent JP 3503139 (B2) mentioned above, red phosphors, as described in laid open Japanese patent application JP 2005-048105 (A), beta-sialon green phosphors, as described in laid open Japanese patent application JP 2007-262417 (A), Ca alfa-sialon red phosphors can also be used. The phosphors above mentioned can be used as ground material and/or as surface modified material dispersed in light conversion layers. Quantum dots as described in WO 2006/017125 may also be used.

The light conversion means in the electro-optical switching elements according to the present invention increases the chromaticity range, improves the uniformity of the distribution of the light from the backlight and suppresses transmission of light having a the short wavelength and hence reduces or even prevents damage to the liquid crystal materials.

The light conversion means used according to the present invention may have e.g. the form a single layer which includes one or a few kinds of organic dyes and/or inorganic phosphors or have the form of stacked layers including different dyes and/or inorganic phosphors in each layer. They further may be more or less continuous or spatially structures respectively patterned.

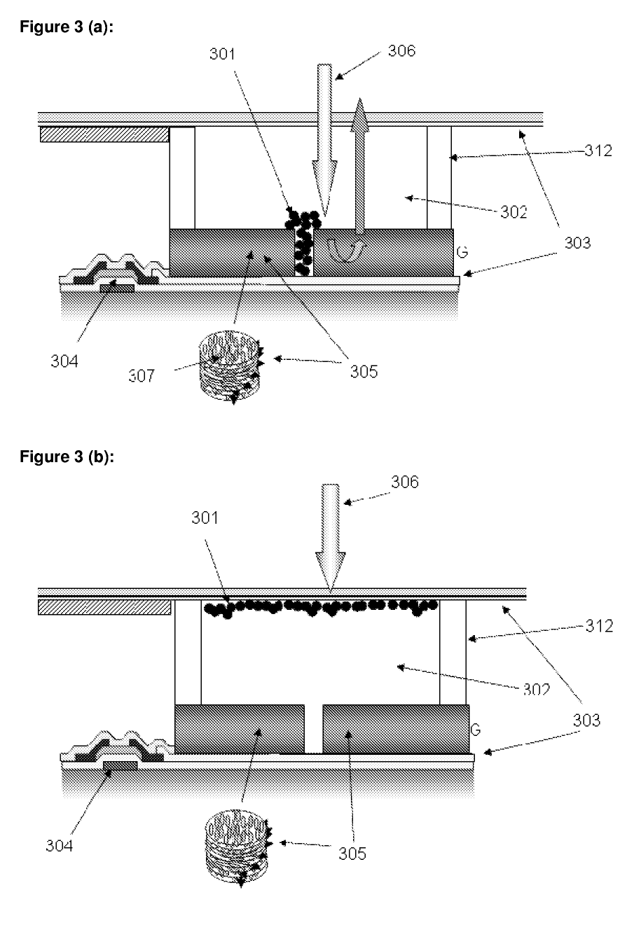

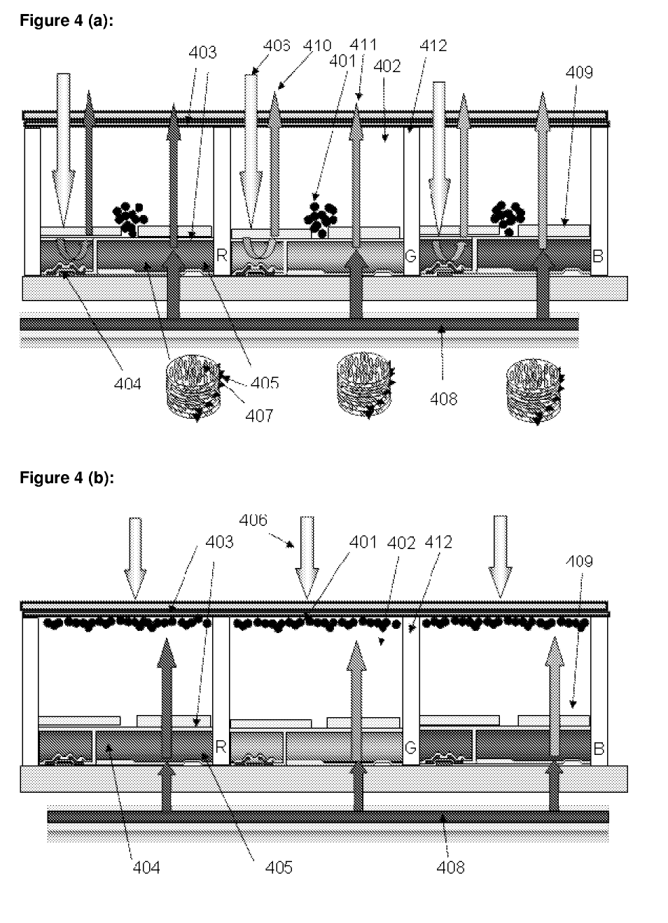

In the third preferred embodiments of the present invention the element used, which is capable of altering, the intensity of light, i.e. to switch or control the intensity of light upon the application of an electrical voltage is an electrophoretic switching element. These embodiments are shown schematically in FIGS. 3 and 4, respectively. In these electrophoretic switching elements charged particles are suspended/dispersed in a fluid medium, preferably a liquid having a low viscosity, in order to allow the realization of displays having fast response times. In one preferred embodiment of the present invention the electrically charged particles are composed of a plastic material, a charge controlling agent and a colouring agent as described in the Japanese laid open patent application JP 2006-058550 (A). As plastic material for example an urethane resin, an urea resin, an acrylate resin and/or a polyester resin may be used. As charge controlling agents introducing a negative charge to the particles e.g. be metal complexes of salicylic acid, azo dyes containing metal atoms or ions, hydrophobic dye materials containing metal ions or atoms, (tertiary) ammonium compounds and boron containing compounds (as e.g. benzylic acid boron complexes*) may be used. As charge controlling agents introducing a positive charge e.g. nigrosine dyes, triphenylmethane compounds, (tertiary) ammonium compounds, polyamine resin and imidazol derivatives may be used. As colouring agents e.g. carbon black, copper oxide, manganese dioxide, aniline black and activated charcoal may be used. As fluids with a low viscosity dry air, nitrogen, inert gas, and/or even vacuum may be used in the cells. As charged particles also those particles described in Japanese laid open patent application JP 2007-240679 (A), where charged coloured pigments, for example, carbon black coated with resins are described, may be used. The cell may be also filled with a transparent liquid, such as water, alcohol and/or oils.

As shown in FIG. 3a, two electrodes (303) are deposited on the substrates, one each on the upper and on the lower substrate cholesteric liquid crystal layers having (a) given twist sense(s) is/are prepared on top of the bottom electrode and a part of said cholesteric liquid crystal layer has a lower thickness than the remaining part of said cholesteric liquid crystal layer. The cholesteric liquid crystal layer may have a concave shape or even a hole reaching to the electrode below.

When a DC voltage having the appropriate polarity is applied to the electrodes, which charges the lower electrode with an electric charge having the opposite sign of the charge of the charged particles (301), the charged particles are collected on the concave part, respectively the missing part, of the layer, as shown in FIG. 3(a). Then the cholesteric liquid crystal layer is revealed in almost all areas of the switching element. Then ambient light (306) is selectively reflected by the cholesteric liquid crystal layer and the light in the wavelength region matching the chiral pitch of the cholesteric liquid crystal layer is strongly reflected. In the reflective mode, which only utilizes the reflected light, a light absorbing material may be placed either on top of or below the lower substrate.

FIG. 3(b) show the situation in the case, when a DC voltage having the opposite polarity from the case illustrated above in FIG. 3(a) is applied to the electrodes. Now the upper electrode is charged with an electric charge having the opposite sign of the charge of the charged particles (301). Consequently the charged particles (301) in this state are collected on the upper electrode and the whole area of the switching element is rendered black.

Such electro-optical switching elements may conveniently be addressed by the active matrix driving method. A voltage may be conveniently applied to the electrodes of the electro-optical switching element via a non-linearly switching electronic element (304), such as e.g. a thin film transistor, and preferably by a thin film transistor, located on at least one of the substrates. In this case a counter electrode is conveniently provided for the substrate opposite to the substrate carrying the TFT(s). Alternatively the voltage applied may be controlled by a passive matrix driving, in which electrodes are prepared on the upper and on the lower substrate, respectively, said electrodes preferably are stripe-shaped and are extending in different directions on either of the substrates, said directions being mutually orthogonal (e.g. perpendicular) to each other, e.g. if line-shaped electrodes on one substrate are extending in the direction of the “x”-axis, those on the other substrate are extending in the direction of the “y”-axis.

In the embodiment shown in FIG. 3, the cholesteric liquid crystal layer is used as a dielectric layer modifying the electrical field of the adjacent electrode of the electro-optical switching element.

As illustrated in FIGS. 4a and 4b, an appropriate dielectric layer (409) may, however, also be fabricated separately and independently of the cholesteric liquid crystal layer (405). The dielectric layer may be composed of inorganic materials such as sputtered films of SiNₓ and/or SiO₂ and/or of organic materials such as photo-polymerizable resins.

FIGS. 4a and 4b do also illustrate another aspect of a further preferred embodiment of the present invention. In the embodiment illustrated in FIG. 3 no light source for the excitation of the cholesteric liquid crystal layer is used. However, it is also possible, and in may cases even advisable, to utilize not only the reflected light (410), but also provide a back light to the electro-optical switching element and use emitted light (411) besides the reflected light (410). In this case a light emitting material, comprising one or more light emitting moieties, (407) is embedded in the cholesteric liquid crystal layer (405), like in the embodiment illustrated in FIG. 2. This light emitting material may be excited by the ambient light and/or by the light of the back light (408). In particular, when a light emitting material showing a small Stokes shift is used, the ambient light alone is sufficient to excite the light emitting material. In the case of a light source (408) is used to excite the light emitting material, a filter, which allows the light for excitation to pass and at the same time absorbs the visible light may be placed between the cholesteric liquid crystal layer and the back light and/or a colour filter may be placed on either side of the upper substrate.

As describe above, in these embodiments of the present invention electro-optical switching elements employing charged particles are used. Besides these electro-optical switching elements, which are employing charged particles, also electrophoretic displays as described in laid open Japanese Patent Application JP H 09-185087 (A) (1997) may be used.

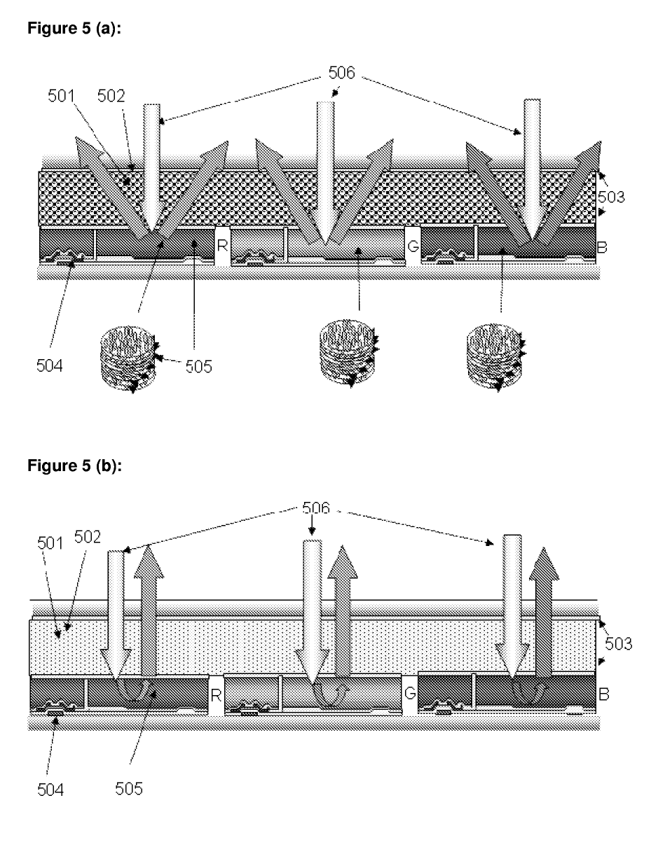

The fourth embodiment of the present invention is using an electro-optical switching element, which is using a composite, consisting of a liquid crystal material having a low molecular weight and of a polymer, e.g. a polymer dispersed liquid crystal display (PDLC) as the optical element that controls the amount of light. This embodiment is schematically illustrated in FIGS. 5a and 5b. The operating principle of the electro-optical switching element is the same as in the case of the polarizer free reflective liquid crystal display utilizing the PDLC and a retro-reflector.

FIG. 5a shows the state, in which the PDLC scatters light. In a normal mode PDLC this is the “unpowered” state, in which no voltage is applied to the respective electrodes on the substrates sandwiching the PDLC layer. In the reverse mode (also called “fail safe mode”) of PDLC is the powered state, i.e. the state in which a voltage of an appropriate magnitude is applied to the respective electrodes on the substrates sandwiching the PDLC layer. The voltage applied to the electrodes in any of these modes is preferably an AC voltage. In some embodiments the voltage applied has a sinus-shaped time function, whereas in some applications a square (respectively rectangular) wave is preferably applies. However also other wave functions may be applied, like e.g. triangular waves or “saw tooth”-shaped waves.

In the scattering state of the PDLC depicted in FIG. 5a, a part of the ambient light (506), which is not scattered by the composite system (e.g. PDLC) consisting of a liquid crystal having a low molecular weight (501) and of a polymer (502), reaches the cholesteric liquid crystal layer (505), is selectively reflected by that cholesteric liquid crystal layer (505) and scattered by the PDLC (501 and 502).

Therefore, an observer is able to observe the light besides the light, which is incident from the direction of the pupil of said observer, and sees the colour of the selective reflection in the pixel.

When the PDLC is in its opposite state, i.e. in the transparent state, as shown schematically in FIG. 5b, the observer does practically see no light at all and the switching element appears black. This holds, in particular, if each cholesteric liquid crystal layer is smaller than the pupil of the human eye. This effect may be understood as follows. The selective reflection of the cholesteric liquid crystal is highly concentrated in a single direction. In the case that the cholesteric liquid crystal layer has an extension, which is smaller than the pupil of the human eye, most of the light reflected is incident from an angle deviating from the direction of the pupil.

In other embodiments, disturbing the twist axes of the cholesteric liquid crystal layers on purpose is effective to enhance the field of view as described e.g. in Japanese laid open patent application JP 2005-003823 (A). However, in the present embodiment, it is highly desirable that the twist axes of all of the cholesteric liquid crystal layers should be aligned in one and the same direction. This type of orientation may be realized rather easily, for example, by the following process. An alignment layer is rubbed mechanically and/or treated photochemically and a layer of a cholesteric liquid crystal is coated on top of the alignment layer. Then, the layer of the cholesteric liquid crystal is heated to a temperature above its clearing point (i.e. the temperature of the transition to the isotropic phase) and then it is allowed to cool down gradually to ambient temperature.

A liquid crystal cell operating in the phase change mode can be used instead of a cell or film operating in the PDLC mode. The liquid crystal material, which is used in the cell operating in the phase change mode, may preferably be either a smectic material, preferably a material exhibiting a S_{A} phase, or a cholesteric material of appropriate pitch. Preferably a cholesteric material is used. These liquid crystal cells are used in the scattering mode and, thus, do not require the use of polarizers. The cholesteric liquid crystal used preferably is changing its state from its scattering focal conic orientation to its planar (or homeotropic) transparent state. These electro-optical modes are particularly useful, as they exhibit a memory effect.

The use of colour filters are not essential according to the present embodiment. But colour filters may be used. They are preferably placed on the upper substrate, i.e. the substrate facing the observer. In case colour filters are used, a decrease of the brightness of the electro-optical switching elements may be observed. However, the reduction of the brightness may be minimized by matching the transmission of the different colours of the colour filter (i.e. the regions of wavelengths of maximum transmission of the respective part of the colour filters) to the regions of the selective reflection of corresponding parts of the cholesteric liquid crystal(s).

Alternatively a layer of a “broad-band” reflective cholesteric liquid crystal, i.e. of a cholesteric liquid crystal showing a “selective” reflection having a broad range of wavelengths, may be applied. Such a broad-band reflective cholesteric liquid crystal may be realized by preparing a cholesteric layer having a cholesteric pitch, which gradually changes e.g. as a function of the location throughout the thickness of the layer. The preparation of such a layer may be simple and straightforward.

The addition of a second layer of a broad-band cholesteric liquid crystal, having the opposite twist sense of twist compared to that of the first layer of broad-band a broad-band cholesteric liquid crystal, results in the realization of the brightest images.

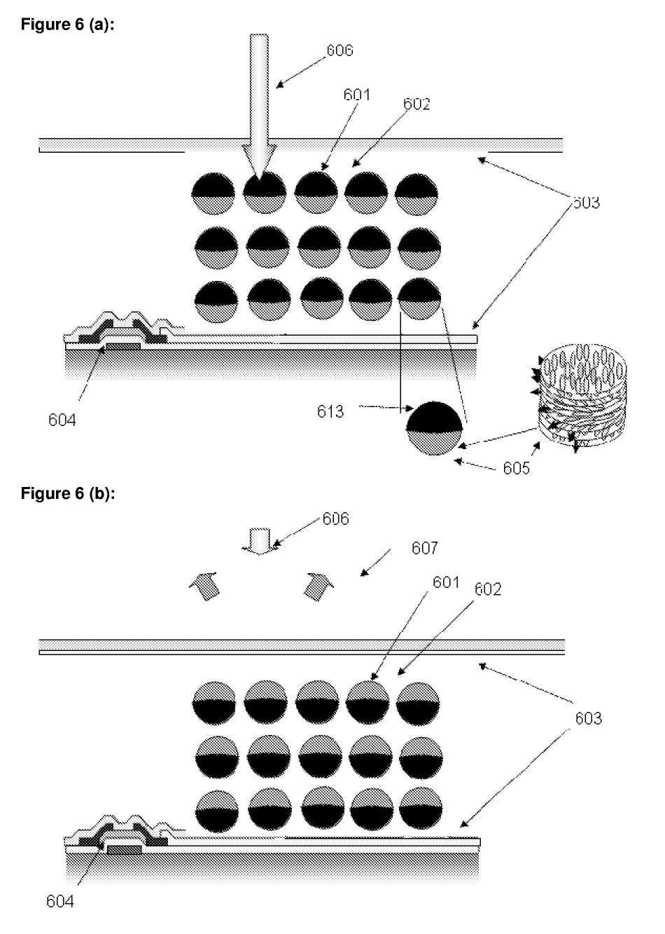

The fifth embodiment of the present invention is also using the electro-gyric effect, exploiting the rotation of the spheres having two oppositely charged semi-spheres in an appropriate electric field as the optical element that controls the amount of reflected light as shown in FIG. 6. Initially the semisphere is covered with cholesteric liquid crystal layer with having a suitable selective reflection, whereas the other semi-sphere is coated with a black substance. Again, as in the case of the conventional electro-gyric displays, the two semi-spheres are charged with an electric charge of opposite signs to each other.

These spheres may be prepared as follows. Similarly to the description in Japanese laid open Patent Application JP H11-085069 (A) (1999), spheres of zinc oxide having an average diameter of 50 μm are immersed in a solution of photo-reactive cholesteric liquid crystal material, e.g. propyleneglycol monomethylether acetate may be used as an organic solvent. Then the spheres are coated with a cholesteric liquid crystal layer. The cholesteric liquid crystal layer is photo-polymerized by UV irradiation. Then the coated spheres are spread on an electrode and, using a Corona discharge, their surface is charged. After exposure of the area, which had been treated by the discharge, to light development using a black toner is performed and finally the toner is fixed by baking (i.e. heating).

Such spheres (601) having two oppositely charged semi-spheres, one being black and the other covered with a layer of cholesteric liquid crystal with suitable selective reflection may also be obtained using the similar method as described in Japanese laid open Patent Application JP H 10-214050 (A) (1998). Small spheres of barium titanate having an average diameter 50 μm are immersed in a solution of a photo-reactive cholesteric liquid crystal material and are covered with a layer of said cholesteric liquid crystal.

After photo-polymerization of the cholesteric liquid crystal of the layer, the spheres are dispersed in a solution of polyvinyl alcohol in water and applied by spin-coating onto a substrate bearing an electrode and then dried. The lower semi-spheres of the spheres are covered with the polyvinyl alcohol. An upper electrode is brought into contact with the spheres and an electric voltage of about 3 kV is applied to the upper and lower electrodes for about 10 hours to polarize the spheres. Then the upper substrate is removed and the lower substrate with spheres are transferred into a vacuum evaporation system. A black material, such as co-evaporated MgF₂ and Sb₂S₃ is evaporated and deposited on one of the two semi-spheres of each one of the spheres. The substrate is then immersed in acetone solution containing a surfactant and the polarized spheres having one semi-sphere covered with cholesteric liquid crystal layer and the other semi-sphere covered with the black material are obtained. The spheres then are dispersed in oil such as silicone oil or in a transparent polymer matrix and sandwiched by two substrates, each provided with an electrode or with an electrodes on their inner sides facing the dispersion of the spheres. Then, by applying a DC voltage of appropriate magnitide an image can be displayed as described e.g. in laid open Japanese patent applications JP H11-085069 (A) (1999) and JP H10-214050 (A) (1998).

In this embodiment the layer of the cholesteric liquid crystal acts as a reflector for light having a high efficiency. It may further comprise materials emitting light. In case it contains such light emitting substance with small Stokes shift and/or quantum dots, not only the selective reflection but also fluorescent (and/or) phosphorescent light may contribute to displaying the image and results in a significantly brighter image.

In all the embodiments colour filters may be applied to create displays providing clearer images, if required.

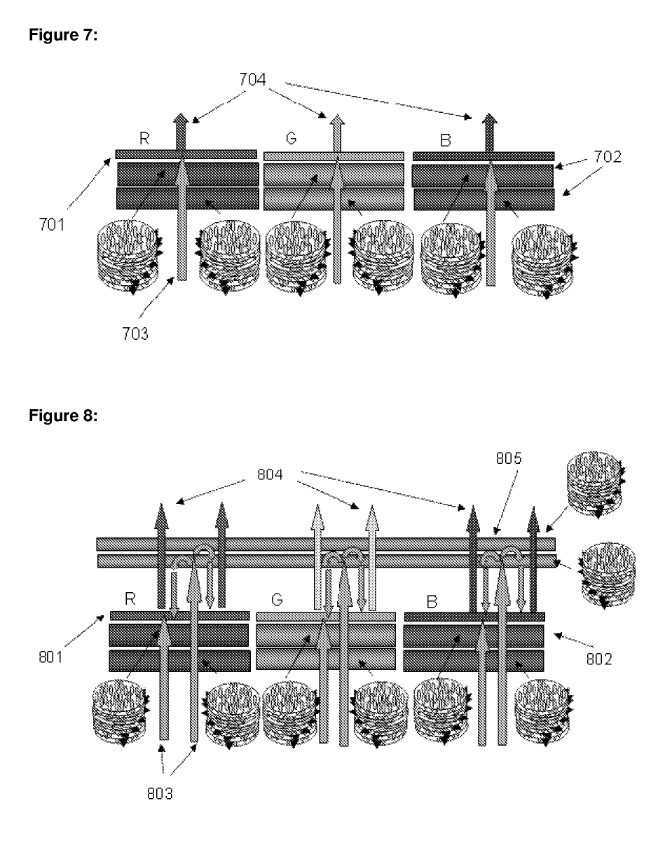

For all the embodiments of the present invention, the material comprising the light emitting moieties may be embedded in an additional layer (711) on the side of the layer of the cholesteric liquid crystal (702), which is facing the observer, as shown in FIG. 7. In this case, preferable effects, for example, a wide variety of matrix substances are available and the light emitted is reflected by the cholesteric liquid crystal layers, can be realized.

Furthermore, cholesteric layers (805) that re-use the excitation light (803) may be used, as illustrated in FIG. 8. The pitch of the cholesteric liquid crystal layers matches the wavelength of excitation light (803). Therefore, the light (804) creating the displayed images is not affected by these layers. The layers of cholesteric liquid crystal may be placed inside the cell. But they may alternatively also be placed outside of the cell. The latter embodiment does lead to a significant simplification of the fabrication process.

The sixth embodiment of the present invention is using small-scale electromechanical switching elements, i.e. micro-mechanical switching elements, as a replacement for the electro-optical switching elements illustrated above. In the terminology of this application the term electro-optical switching element comprises also these micro-mechanical switching elements. Typical examples of such micro-mechanical switching elements are hinged micro-mirrors, as e.g. used in Texas Instruments “Digital Light Processing (DLP®)”-devices or micro-mechanical shutters (MEMS) as disclosed in Hagood, N., Steyn, L., Fijil, J. Gandhi, J., Brosnihan, T., Lewis, S., Fike, G., Barton, R. Halfman, M., and Payne, Richard, “MEMMS-Based Direct View Displays using Digital Micro Shutters”, Proceedings of IDW '08, pages 1345-1348. These MEMS shutters, also referred to as “Digital Micro Shutter, short DMS®”, use movable parts having dimensions in the range of some μm as mechanical shutters in order to mechanically block the passage of light. The shutters are activated by the application of an electrical field. In these electro-optical switching elements a layers of cholesteric liquid crystals reflecting light of the appropriate colour are beneficially fabricated inside the device on the side facing the light source, i.e. in the slots through which the light is passing prior to reaching the microscopic shutter itself. Preferably an array of cholesteric layers, one each for one sub-pixel is fabricated. It is possible to use a single cholesteric layer of the appropriate spectral characteristics in each one sub-pixel. This cholesteric layer may have either one of the two possible helical twisting senses. However, especially in view of optimization of the intensity of light reflected, preferably a stack of two cholesteric layers having mutually opposite twisting sense is used. These cholesteric liquid crystal layers may comprise materials comprising light emitting moieties, such as fluorescent dyes or phosphors. Due to the intrinsic colouration of the cholesteric liquid crystal layers used these devices do not require the use of a colour filter in order to render coloured images. Further the colouration of the respective parts of the cholesteric liquid crystal layers in each sub-pixel, which preferably covers the full area width of the light path from the light source, eliminated parallax problems, experienced in typical MEMS devices. In order to improve the operation of these devices it is often desirable to use a light source having a rather short wave length of emission, preferably of 470 nm or below, e.g. of 400 nm. These wavelengths are preferable for the excitation of the light emitting moieties. However, a smaller wavelength is not desired in most cases as it may lead to degradation of the various materials used. Especially preferred as light sources here are LEDs.

Besides natural ambient light, light from a light source may be used to excite the light emitting substance. For this light, for example, light having a wavelength in the range from between 400 nm and 470 nm, is preferably used for irradiation. Then brighter images can be displayed even under dim or dark ambient illumination conditions.

According to the present application, light used for excitation preferably is light with a wavelength of 400 nm or more, i.e. including violet light, but no UV radiation, preferably it is light with a wavelength of 420 nm or more and, most preferably, of 435 nm or more.

According to the present invention all known LCD modes may be applied for the liquid crystal switching layer, like for example the twisted nematic (TN) mode and the vertical alignment (VA) mode.

Preferred embodiments of the present application are also obvious for the expert from the claims filed with this application, which in this respect form a part of the disclosure of the instant application.

The melting point T(C,N), the transition from the smectic (S) to the nematic (N) phase T(S,N) and the clearing point T(N,I) of the liquid crystals are given in degrees centigrade.

In the present application all temperatures are given in degrees centigrade (degrees Celsius, short ° C.), all physical data apply to a temperature of 20° C. and all concentrations are weight percent (% respectively wt.-%), all unless explicitly stated otherwise.

### EXAMPLES

The present invention is illustrated in more detail by the following examples. They are intended to illustrate the present invention, without limiting it in any way.

However, the different embodiments, including their compositions, constitutions and physical properties, illustrate to the expert very well, which properties can be achieved by the present invention and also, in particular, in which ranges they can be modified. Especially the combination of the various properties, which can be preferably achieved, is thus well defined for the expert.

### Example 1

Six layers of cholesteric liquid crystal, which correspond to blue, green and red selective reflections and two twist senses for each colour are prepared using the photo-polymerizable liquid crystal material RMM34C, a mixture of reactive mesogens comprising a photo-initiator, which is commercially available from Merck KGaA, Germany. Chiral dopants are BDH1281 (also available from Merck KGaA) for right-hand twist and S-5011 (also available from Merck KGaA) for left-hand twist. The concentrations of the chiral dopant are 4.54% (B), 3.78% (G) and 3.00% (R) for BDH1281 and 2.87% (B), 2.44% (G) and 1.95% (R) for S-5011, respectively.

Glass substrates are cleaned and dried as usual and then a water solution of the polyvinylalcohol (PVA) from Tokyo Kasei, Japan is applied by spin-coating at 1,500 rpm. Then the substrates are cured at a temperature of 80° C. for 30 min and subsequently rubbed in one direction each. RMM34C doped with each chiral dopant is dissolved in propylene glycol monomethyl ether acetate (PGMEA) and 60% solution is spin-coated at 1,500 rpm on the substrate covered with rubbed PVA. Each substrate is then dried at a temperature of 60° C. for 30 min. The cholesteric liquid crystal structure formed by this process is then stabilized by polymerization initiated by exposure to (2,000±50) mJ/cm² of irradiation by UV having a wavelength of 365 nm.

Reflection spectra of the resulting layer of the cholesteric liquid crystal are measured using a luminance meter, CS-1000 (Konica Minolta Holdings, Inc., Japan) and an incandescent lamp, Fiber Lite Model 190 from Dolan-Jenner Industries, Inc., as a light source. The incident light is 30° tilted from the vertical direction to the substrate and the reflection is detected from the vertical direction. Either an R-circular polarizer or an L-circular polarizer is placed on a cholesteric liquid crystal layer with the side of its quarter wave plate facing the cholesteric layer. As a reference a perfect scattering plate is used and the relative reflected light intensity is measured.

Here, an R-circular polarizer (from MeCan Imaging Inc., Japan), which transmits only right-hand circularly polarized light can be realized by placing a quarter wave plate having wide range of wavelengths to a linear polarizer so that its optical axis is twisted clockwise by 45° against the axis of transmission of polarizer. An L-circular polarizer (from MeCan Imaging Inc., Japan) which transmits only the circular polarized light having left-handed sense of rotation consists of a combination of a linear polarizer and a quarter wave plate, in which the slow axis of the quarter wave plate is rotated by 45° relative to the absorption axis of the polarizer.

The results for right-hand twist cholesteric liquid crystal layers are shown in Table 1. As can clearly be seen only right-hand circularly polarized light is reflected in each selective reflection wavelength region. The results for the left-hand twist cholesteric liquid crystal layer (Table 2) are almost the same and which results differ only in the point that the right-handed sense and the left-handed sense become reversed.

TABLE 1
Relative intensity of reflection of the right-hand twist cholesteric
liquid crystal layers

| | Colour | | | | | |
|---|---|---|---|---|---|---|
| | Blue | | Green | | Red | |
| | Polarizer | | | | | |
| | Right* | Left^{#} | Right* | Left^{#} | Right* | Left^{#} |
| λ/nm | Intensity of Light W /10⁻³ (sr · m² · nm) | | | | | |
| 380 | 0.839 | n.d. | 1.724 | n.d. | 0.372 | n.d. |
| 390 | 1.353 | 0.720 | 1.294 | 0.840 | 0.630 | 0.130 |
| 400 | 0.698 | 0.174 | 0.520 | 0.246 | 0.248 | 0.101 |
| 410 | 0.618 | 0.109 | 0.484 | 0.138 | 0.134 | 0.072 |
| 420 | 0.633 | 0.093 | 0.519 | 0.111 | 0.117 | 0.062 |
| 430 | 0.632 | 0.080 | 0.548 | 0.095 | 0.113 | 0.055 |
| 440 | 0.585 | 0.068 | 0.567 | 0.083 | 0.112 | 0.050 |
| 450 | 0.498 | 0.058 | 0.576 | 0.074 | 0.113 | 0.045 |
| 460 | 0.294 | 0.050 | 0.600 | 0.069 | 0.117 | 0.041 |
| 470 | 0.165 | 0.045 | 0.590 | 0.060 | 0.119 | 0.038 |
| 480 | 0.112 | 0.041 | 0.610 | 0.057 | 0.122 | 0.034 |
| 490 | 0.086 | 0.038 | 0.706 | 0.056 | 0.125 | 0.032 |
| 500 | 0.075 | 0.037 | 0.750 | 0.055 | 0.137 | 0.030 |
| 510 | 0.068 | 0.035 | 0.769 | 0.054 | 0.144 | 0.029 |
| 520 | 0.064 | 0.033 | 0.733 | 0.053 | 0.151 | 0.027 |
| 530 | 0.061 | 0.031 | 0.665 | 0.049 | 0.160 | 0.026 |
| 540 | 0.059 | 0.030 | 0.583 | 0.046 | 0.170 | 0.025 |
| 550 | 0.058 | 0.029 | 0.455 | 0.044 | 0.193 | 0.025 |
| 560 | 0.058 | 0.028 | 0.270 | 0.041 | 0.221 | 0.025 |
| 570 | 0.058 | 0.028 | 0.146 | 0.039 | 0.254 | 0.026 |
| 580 | 0.058 | 0.027 | 0.098 | 0.037 | 0.287 | 0.027 |
| 590 | 0.057 | 0.027 | 0.072 | 0.036 | 0.349 | 0.030 |
| 600 | 0.057 | 0.027 | 0.061 | 0.036 | 0.452 | 0.035 |
| 610 | 0.057 | 0.026 | 0.055 | 0.035 | 0.477 | 0.036 |
| 620 | 0.058 | 0.027 | 0.053 | 0.035 | 0.500 | 0.037 |
| 630 | 0.059 | 0.027 | 0.051 | 0.035 | 0.527 | 0.037 |
| 640 | 0.059 | 0.027 | 0.052 | 0.036 | 0.498 | 0.034 |
| 650 | 0.060 | 0.027 | 0.052 | 0.036 | 0.438 | 0.031 |
| 660 | 0.061 | 0.028 | 0.052 | 0.037 | 0.369 | 0.029 |
| 670 | 0.061 | 0.028 | 0.053 | 0.038 | 0.301 | 0.028 |
| 680 | 0.061 | 0.028 | 0.053 | 0.038 | 0.237 | 0.026 |
| 690 | 0.062 | 0.028 | 0.053 | 0.038 | 0.174 | 0.025 |
| 700 | 0.062 | 0.028 | 0.055 | 0.039 | 0.129 | 0.025 |
| 710 | 0.061 | 0.028 | 0.055 | 0.039 | 0.101 | 0.024 |
| 720 | 0.063 | 0.029 | 0.058 | 0.040 | 0.085 | 0.024 |
| 730 | 0.066 | 0.031 | 0.061 | 0.042 | 0.078 | 0.025 |
| 740 | 0.069 | 0.033 | 0.065 | 0.045 | 0.076 | 0.027 |
| 750 | 0.072 | 0.036 | 0.067 | 0.048 | 0.076 | 0.029 |
| 760 | 0.072 | 0.038 | 0.069 | 0.049 | 0.076 | 0.030 |
| 770 | 0.071 | 0.039 | 0.071 | 0.052 | 0.075 | 0.031 |
| 780 | 0.069 | 0.041 | 0.072 | 0.053 | 0.075 | 0.032 |

Remarks:
*Right: with right-handed circular polarizer,
^{#}Left: with left-handed circular polarizer) and
n.d.: not determined.

TABLE 2
Relative intensity of reflection of the left-hand twist cholesteric
liquid crystal layers

| | Colour | | | | | |
|---|---|---|---|---|---|---|
| | Blue | | Green | | Red | |
| | Polarizer | | | | | |
| | Right* | Left^{#} | Right* | Left^{#} | Right* | Left^{#} |
| λ/nm | Intensity of Light W/10⁻³ (sr · m² · nm) | | | | | |
| 380 | 0.516 | 0.367 | 2.313 | 0.915 | 2.046 | 0.000 |
| 390 | 0.528 | 0.731 | 0.533 | 0.726 | 0.442 | 0.390 |
| 400 | 0.263 | 0.408 | 0.227 | 0.617 | 0.197 | 0.161 |
| 410 | 0.149 | 0.279 | 0.118 | 0.521 | 0.102 | 0.105 |
| 420 | 0.122 | 0.275 | 0.101 | 0.573 | 0.081 | 0.094 |
| 430 | 0.105 | 0.291 | 0.095 | 0.592 | 0.070 | 0.091 |
| 440 | 0.094 | 0.315 | 0.089 | 0.629 | 0.063 | 0.090 |
| 450 | 0.085 | 0.351 | 0.080 | 0.629 | 0.057 | 0.091 |
| 460 | 0.076 | 0.388 | 0.069 | 0.568 | 0.053 | 0.093 |
| 470 | 0.071 | 0.432 | 0.061 | 0.382 | 0.048 | 0.096 |
| 480 | 0.071 | 0.571 | 0.056 | 0.212 | 0.045 | 0.099 |
| 490 | 0.072 | 0.645 | 0.052 | 0.136 | 0.042 | 0.102 |
| 500 | 0.074 | 0.692 | 0.050 | 0.099 | 0.040 | 0.110 |
| 510 | 0.074 | 0.707 | 0.048 | 0.079 | 0.039 | 0.119 |
| 520 | 0.069 | 0.671 | 0.047 | 0.069 | 0.038 | 0.127 |
| 530 | 0.062 | 0.588 | 0.046 | 0.064 | 0.036 | 0.135 |
| 540 | 0.055 | 0.436 | 0.045 | 0.060 | 0.036 | 0.146 |
| 550 | 0.051 | 0.260 | 0.045 | 0.058 | 0.035 | 0.164 |
| 560 | 0.047 | 0.152 | 0.045 | 0.056 | 0.035 | 0.197 |
| 570 | 0.044 | 0.107 | 0.045 | 0.055 | 0.035 | 0.213 |
| 580 | 0.042 | 0.081 | 0.045 | 0.054 | 0.035 | 0.265 |
| 590 | 0.041 | 0.069 | 0.045 | 0.054 | 0.035 | 0.300 |
| 600 | 0.040 | 0.063 | 0.046 | 0.053 | 0.038 | 0.394 |
| 610 | 0.040 | 0.060 | 0.046 | 0.054 | 0.039 | 0.413 |
| 620 | 0.040 | 0.058 | 0.047 | 0.054 | 0.041 | 0.416 |
| 630 | 0.040 | 0.057 | 0.047 | 0.055 | 0.044 | 0.429 |
| 640 | 0.040 | 0.057 | 0.048 | 0.055 | 0.045 | 0.392 |
| 650 | 0.040 | 0.056 | 0.049 | 0.056 | 0.045 | 0.308 |
| 660 | 0.040 | 0.056 | 0.050 | 0.057 | 0.045 | 0.247 |
| 670 | 0.040 | 0.056 | 0.051 | 0.058 | 0.047 | 0.192 |
| 680 | 0.040 | 0.056 | 0.051 | 0.058 | 0.046 | 0.144 |
| 690 | 0.040 | 0.055 | 0.052 | 0.058 | 0.046 | 0.101 |
| 700 | 0.040 | 0.055 | 0.052 | 0.058 | 0.046 | 0.076 |
| 710 | 0.040 | 0.055 | 0.052 | 0.058 | 0.045 | 0.061 |
| 720 | 0.041 | 0.056 | 0.052 | 0.059 | 0.046 | 0.051 |
| 730 | 0.042 | 0.057 | 0.054 | 0.061 | 0.048 | 0.048 |
| 740 | 0.043 | 0.059 | 0.057 | 0.063 | 0.051 | 0.049 |
| 750 | 0.046 | 0.062 | 0.060 | 0.067 | 0.053 | 0.051 |
| 760 | 0.048 | 0.064 | 0.062 | 0.069 | 0.055 | 0.053 |
| 770 | 0.050 | 0.065 | 0.063 | 0.071 | 0.055 | 0.056 |
| 780 | 0.051 | 0.065 | 0.063 | 0.071 | 0.055 | 0.060 |

Remarks:
*Right: with right-handed circular polarizer,
^{#}Left: with left-handed circular polarizer)

The dichroic dyes F355, F357 and F593, all commercially available from Merck KGaA, Germany, are incorporated into liquid crystals ZLI-3449-100 and MLC-6609, both also commercially available from Merck KGaA, Germany. Physical properties of ZLI-3449-100 and MLC-6609 are shown in Table 3. Two kinds of cells are prepared. A cell of type (1), which has patterned ITO electrode covered with polyimide inducing homogeneous alignment which is treated with anti-parallel rubbing and has a cell gap of 10 μm and a cell of type (2), which has a patterned ITO electrode covered with polyimide inducing homogeneous alignment, which is treated with perpendicular rubbing (leading to a twisted nematic state) and has a cell gap of 6 μm.

TABLE 3
Physical properties of LC mixtures ZLI-3449-100 and MLC-6609

| LC | ZLI-3449-100 | MLC-6609 |
|---|---|---|
| Clearing Point/° C. | 92.5 | 91.5 |
| Δn | 0.1325 | 0.0777 |
| nₑ | 1.6335 | 1.55 |
| nₒ | 1.501 | 1.47 |
| Δ_{ε} | 7.8 | −3.7 |
| ε_{//} | 11.7 | 3.4 |
| ε_{⊥} | 3.9 | 7.1 |

In order to check the dichroic ratio and absorption wavelength range of the dichroic dyes F355, F357 and F593, each dye is doped into ZLI-3449-100 at a concentration of 1%. The respective mixture is injected into the cell of type (1) described above. Its absorption spectra for the linearly polarized light both parallel and perpendicular to the rubbing direction are shown in Table 4. Obviously a high dichroic ratio is achieved in a visible wavelength region.

TABLE 4
Absorbance of the three dyes, F355, F357 and F593 in ZLI-3449-
100 with a concentration of 1% in an anti-parallel rubbed cell.

| | | |
|---|---|---|
| Orientation | Parallel | Perpendicular |

| | |
|---|---|
| λ/nm | Absorbance |

| | | |
|---|---|---|
| 400 | 2.276 | 0.876 |
| 410 | 2.188 | 0.627 |
| 420 | 2.360 | 0.556 |
| 430 | 2.463 | 0.531 |
| 440 | 2.543 | 0.525 |
| 450 | 2.622 | 0.528 |
| 460 | 2.647 | 0.531 |
| 470 | 2.608 | 0.529 |
| 480 | 2.611 | 0.531 |
| 490 | 2.680 | 0.503 |
| 500 | 2.814 | 0.444 |
| 510 | 2.784 | 0.442 |
| 520 | 2.788 | 0.450 |
| 530 | 2.828 | 0.455 |
| 540 | 2.876 | 0.456 |
| 550 | 2.908 | 0.454 |
| 560 | 2.928 | 0.449 |
| 570 | 2.911 | 0.441 |
| 580 | 2.874 | 0.432 |
| 590 | 2.814 | 0.420 |
| 600 | 2.730 | 0.405 |
| 610 | 2.621 | 0.387 |
| 620 | 2.503 | 0.371 |
| 630 | 2.380 | 0.358 |
| 640 | 2.266 | 0.343 |
| 650 | 2.158 | 0.329 |
| 660 | 2.060 | 0.318 |
| 670 | 1.965 | 0.306 |
| 680 | 1.871 | 0.295 |
| 690 | 1.774 | 0.285 |
| 700 | 1.677 | 0.273 |
| 710 | 1.574 | 0.262 |
| 720 | 1.466 | 0.254 |
| 730 | 1.356 | 0.246 |
| 740 | 1.255 | 0.236 |

The TN cell used as the switching element is fabricated as follows. The nematic liquid crystalline mixture ZLI-3449-100 doped with the dichroic dyes F355, F357 and F593, each at a concentration of 3% is filled into a cell of type (2) described above. This is placed in front of the two stacked layers of the cholesteric liquid crystal layers whose reflection properties are shown in Tables 1 and 2. Reflection of this assembly is measured in a similar way to the measurement of the cholesteric liquid crystal layer itself. The incident light is again tilted 30° from the vertical direction to the substrate and the reflection is detected from the vertical direction. No polarizer is used in this measurement. Reflection spectra for each colour once with out application of a voltage (i.e. with a voltage of 0 V) and once applying a voltage of 40 V to the TN cell are shown in Tables 5, 6 and 7, for blue, green and red reflection, respectively. It is clearly shown that each colour is switched by TN cell containing a dichroic dye.

TABLE 5
Relative reflection Intensity from 2-stacked Cholesteric liquid
crystal layers in blue, green and red spectral regions

| | Colour | | | | | |
|---|---|---|---|---|---|---|
| | Blue | | Green | | Red | |
| | U_{appl.}/V | | | | | |
| | 0 | 40 | 0 | 40 | 0 | 40 |
| λ/nm | Intensity of Light W /10⁻³ (sr · m² · nm) | | | | | |
| 380 | 15.67 | 35.49 | 2.837 | 23.06 | n.d. | n.d. |
| 390 | 14.06 | 32.78 | 9.519 | 24.60 | n.d. | n.d. |
| 400 | 12.82 | 30.42 | 10.17 | 26.43 | n.d. | n.d. |
| 410 | 11.88 | 28.53 | 9.393 | 25.42 | n.d. | n.d. |
| 420 | 11.17 | 27.51 | 9.028 | 24.92 | n.d. | n.d. |
| 430 | 10.73 | 27.48 | 8.618 | 24.23 | n.d. | n.d. |
| 440 | 10.54 | 28.51 | 8.581 | 24.80 | n.d. | n.d. |
| 450 | 10.18 | 28.28 | 8.935 | 26.04 | n.d. | n.d. |
| 460 | 10.36 | 31.68 | 9.796 | 28.83 | n.d. | n.d. |
| 470 | 8.062 | 24.98 | 10.79 | 31.32 | n.d. | n.d. |
| 480 | 5.914 | 16.42 | 12.72 | 38.37 | n.d. | n.d. |
| 490 | 4.071 | 10.36 | 13.64 | 44.64 | n.d. | n.d. |
| 500 | 3.412 | 8.277 | 14.70 | 48.65 | 4.966 | 11.93 |
| 510 | 3.045 | 7.194 | 15.01 | 49.25 | 5.224 | 12.75 |
| 520 | 2.827 | 6.453 | 14.03 | 47.73 | 5.307 | 13.04 |
| 530 | 2.641 | 5.917 | 11.66 | 41.08 | 5.379 | 13.35 |
| 540 | 2.477 | 5.455 | 9.841 | 31.59 | 5.273 | 13.20 |
| 550 | 2.484 | 5.287 | 7.707 | 22.93 | 5.690 | 14.20 |
| 560 | 2.505 | 5.266 | 5.582 | 14.87 | 5.897 | 14.95 |
| 570 | 2.615 | 5.359 | 4.236 | 10.11 | 6.759 | 17.64 |
| 580 | 2.778 | 5.677 | 3.611 | 8.194 | 7.569 | 19.97 |
| 590 | 2.987 | 6.106 | 3.663 | 7.888 | 9.109 | 24.09 |
| 600 | 3.291 | 6.756 | 3.717 | 8.000 | 11.42 | 31.50 |
| 610 | n.d. | n.d. | n.d. | n.d. | 14.25 | 41.62 |
| 620 | n.d. | n.d. | n.d. | n.d. | 17.06 | 52.67 |
| 630 | n.d. | n.d. | n.d. | n.d. | 19.14 | 63.60 |
| 640 | n.d. | n.d. | n.d. | n.d. | 21.42 | 75.94 |
| 650 | n.d. | n.d. | n.d. | n.d. | 22.67 | 80.03 |
| 660 | n.d. | n.d. | n.d. | n.d. | 21.30 | 74.60 |
| 670 | n.d. | n.d. | n.d. | n.d. | 19.79 | 69.46 |
| 680 | n.d. | n.d. | n.d. | n.d. | 19.58 | 66.40 |
| 690 | n.d. | n.d. | n.d. | n.d. | 19.03 | 58.90 |
| 700 | n.d. | n.d. | n.d. | n.d. | 17.77 | 50.15 |
| 710 | n.d. | n.d. | n.d. | n.d. | 17.05 | 43.46 |
| 720 | n.d. | n.d. | n.d. | n.d. | 17.05 | 38.36 |
| 730 | n.d. | n.d. | n.d. | n.d. | 18.20 | 36.39 |
| 740 | n.d. | n.d. | n.d. | n.d. | 20.36 | 35.82 |
| 750 | n.d. | n.d. | n.d. | n.d. | 22.92 | 35.45 |
| 760 | n.d. | n.d. | n.d. | n.d. | 25.00 | 34.94 |
| 770 | n.d. | n.d. | n.d. | n.d. | 26.45 | 34.13 |
| 780 | n.d. | n.d. | n.d. | n.d. | 27.81 | 33.36 |

Remarks:
n.d.: not determined.

### Example 2

In a similar way as in the example 1, a cholesteric liquid crystal layer with fluorescent dye is fabricated as follows. A cell of a third type (type (3) is prepared. To this end cleaned and dried glass substrates are spin-coated at 1,500 rpm with an appropriate solution of the polyimide alignment layer SE-7492 from Nissan Chemical Co.^{Ltd}, Japan. The substrates are pre-heated at 100° C. for 3 min. and then cured at 200° C. for 1 h and subsequently rubbed in one direction. Commercially available polyimide (Kapton Film H type 50H from Du Pont) with a thickness of 12.5 μm is used as a spacer between two substrates and the substrates are assembled with anti-parallel rubbing directions and fixed using polyimide adhesive tape.

The cholesteric liquid crystal layer is prepared using a photo-polymerizable liquid crystal material RMM34C, commercially available from Merck KGaA, Germany, doped with the commercially available chiral dopant BDH1281 (also from Merck KGaA). The concentration of the chiral dopant in RMM34C was 4.54%. The blue dye coumarin-500, available from Exciton Corporation, USA via Indeco Corporation, Japan, is incorporated into this polymerizable mixture in a concentration of 2.74%. The mixture is introduced into a liquid crystal cell of type (3), as described in the paragraph directly above. The cell with the mixture is heated up to a temperature of 80° C., at which temperature the mixture it is in the isotropic phase, and subsequently cooled down to a temperature of 25° C. at the cooling rate of 0.1°/min. Then the cholesteric LC structure is stabilized by polymerization, which is initiated by exposure to irradiation by UV. UV radiation with a wavelength of 365 nm is used and the dose of exposure is (2,000±50) mJ/cm².

The properties of the cholesteric LC layer are investigated in a way similar to that described in example 1. The spectra in emission and in reflection from the dye doped cholesteric liquid crystal layer are measured using a luminance meter, CS-1000 (Konica Minolta Holdings, Inc., Japan). For the excitation an LED with a wavelength of 400 nm (LB-50/150UV-400 from Dynatec Co.^{Ltd}) is used. Whereas for the measurement of the reflection an incandescent lamp (Fiber Lite Model 190 from Dolan-Jenner Industries, Inc.) is used. Here again, the incident light is tilted 30° from the vertical direction to the substrate and the reflection is detected from the vertical direction. The results are shown in Table 6 (a) for the emission spectra and in Table 6 (b) for the reflection spectra (in the three cases when no polarizer is used, when an R-circularly polarizer is used and when an L-circularly polarizer is used, respectively). The emission peak is located at a wavelength of about 467 nm and the reflection peak, which clearly is a selective reflection peak, is located at a wavelength of about 460 nm.

TABLE 6 (a)
Emission Spectrum of a Cholesteric LC layer

| | Emission Energy |
|---|---|
| λ/nm | W/10⁻³ (sr · m² · nm) |
| 430 | 46.65 |
| 435 | 36.65 |
| 440 | 31.15 |
| 445 | 27.56 |
| 450 | 25.41 |
| 455 | 25.06 |
| 460 | 25.88 |
| 465 | 26.53 |
| 470 | 26.10 |
| 475 | 24.84 |
| 480 | 23.34 |
| 485 | 21.38 |
| 490 | 20.30 |
| 495 | 19.24 |
| 500 | 18.26 |

TABLE 6 (b)
Reflection Spectra of a Cholesteric LC layer

| | | Right- | Right- |
|---|---|---|---|
| | None | Handed | Handed |
| Polarizer | Intensity of Reflection | | |
| λ/nm | W/10⁻³ (sr · m² · nm) | | |
| 430 | 3.366 | 1.569 | 0.193 |
| 435 | 3.853 | 1.868 | 0.219 |
| 440 | 4.288 | 2.141 | 0.242 |
| 445 | 4.663 | 2.386 | 0.264 |
| 450 | 4.983 | 2.599 | 0.284 |
| 455 | 5.216 | 2.748 | 0.304 |
| 460 | 5.205 | 2.745 | 0.322 |
| 465 | 4.884 | 2.557 | 0.338 |
| 470 | 4.277 | 2.195 | 0.351 |
| 475 | 3.627 | 1.793 | 0.364 |
| 480 | 3.073 | 1.440 | 0.374 |
| 485 | 2.635 | 1.155 | 0.382 |
| 490 | 2.326 | 0.952 | 0.385 |
| 495 | 2.104 | 0.806 | 0.385 |
| 500 | 2.010 | 0.728 | 0.395 |

Similar to the case of example 1, the dichroic dye F357, commercially available from Merck KGaA, Germany, is incorporated into the two liquid crystals ZLI-3449-100 and MLC-6609, also both commercially available from Merck KGaA, Germany. The physical properties of these mixtures are already shown in Table 3 above.

In order to check the dichroic ratio and absorption wavelength range of the dichroic dye F357, 10% of F357 are doped into the mixture MLC-6609 and the resultant mixture is injected into a cell of type (1), an LC cell, which has patterned ITO electrode covered with polyimide inducing homogeneous alignment, which is treated with anti-parallel rubbing and has a cell gap of 10 μm, as described in the example 1. The spectra of this cell for absorption of linearly polarized light parallel and perpendicular to the rubbing direction are shown in Table 7. It is clearly seen that the F357 has an absorption in the blue region of the visible spectrum.

TABLE 7
Spectral characteristics of F357 in MLC-6609

| | | |
|---|---|---|
| Orientation | Parallel | Perpendicular |

| | |
|---|---|
| λ/nm | Absorbance |

| | | |
|---|---|---|
| 400 | 2.600 | 0.298 |
| 410 | 2.875 | 0.338 |
| 420 | 3.051 | 0.387 |
| 430 | 3.172 | 0.418 |
| 440 | 3.219 | 0.414 |
| 450 | 3.250 | 0.413 |
| 460 | 3.277 | 0.375 |
| 470 | 3.235 | 0.314 |
| 480 | 3.219 | 0.272 |
| 490 | 2.982 | 0.228 |
| 500 | 2.255 | 0.156 |
| 510 | 1.542 | 0.104 |
| 520 | 1.084 | 0.067 |
| 530 | 0.776 | 0.045 |
| 540 | 0.556 | 0.023 |
| 550 | 0.393 | 0.013 |
| 560 | 0.265 | −0.003 |
| 570 | 0.171 | −0.009 |
| 580 | 0.102 | −0.017 |
| 590 | 0.052 | −0.024 |
| 600 | 0.019 | −0.025 |

Similar to investigation described in example 1, here ZLI-3449-100 doped with 3% F357 is injected into a cell of type (2), a TN cell, a having a patterned ITO electrode covered with polyimide inducing homogeneous alignment, which is treated by rubbing and assembled with the respective rubbing directions of the two substrates perpendicular to each other (which after the assembly leads to the twisted nematic state) and having a cell gap of 6 μm. The spectra both in transmission and in reflection, for this TN cell comprising dye doped ZLI-3449-100 placed in front of the cholesteric liquid crystal layer, whose optical properties are shown in Tables 6 (a) above and (b), are measured using luminance meter CS-1000 (Konica Minolta Holdings, Inc., Japan), too. For excitation an LED with a wavelength of 400 nm is used here again. The results are shown in Table 8 (a) (transmission spectra) and Table 8 (b) (reflection spectra). It is clearly shown that upon application of an appropriate voltage both the transmission and the reflection increase and both the transmission and the reflection can be tuned by a cell comprising a liquid crystal doped with dichroic dye.

TABLE 8 (a)
Emission Spectra of an Assembly of a TN Cell and a
Cholesteric LC layer for Various Voltages Applied

U_{appl.}/V

| | 0.0 | 1.0 | 2.0 | 3.0 | 4.0 | 5.0 |
|---|---|---|---|---|---|---|
| λ/nm | Intensity of Emission W /10⁻³ (sr · m² · nm) | | | | | |
| 430 | 16.13 | 16.2 | 15.92 | 16.32 | 19.42 | 21.53 |
| 435 | 12.95 | 12.9 | 12.86 | 13.26 | 15.83 | 17.30 |
| 440 | 11.64 | 11.7 | 11.48 | 11.80 | 14.12 | 15.60 |
| 445 | 10.73 | 10.7 | 10.61 | 10.96 | 13.14 | 14.35 |
| 450 | 10.33 | 10.2 | 10.13 | 10.34 | 12.49 | 13.85 |
| 455 | 10.34 | 10.3 | 10.22 | 10.75 | 12.82 | 14.07 |
| 460 | 10.95 | 10.9 | 10.90 | 11.45 | 13.63 | 15.03 |
| 465 | 11.36 | 11.3 | 11.38 | 12.71 | 14.85 | 16.15 |
| 470 | 11.82 | 11.7 | 11.86 | 13.19 | 15.46 | 16.68 |
| 475 | 11.34 | 11.2 | 11.56 | 13.44 | 15.68 | 16.97 |
| 480 | 11.26 | 11.1 | 11.55 | 13.26 | 15.13 | 16.18 |
| 485 | 10.55 | 10.5 | 10.98 | 12.82 | 14.80 | 15.89 |
| 490 | 10.30 | 10.3 | 10.83 | 12.90 | 14.48 | 15.37 |
| 495 | 10.32 | 10.2 | 10.89 | 12.83 | 14.36 | 15.22 |
| 500 | 10.13 | 10.1 | 10.86 | 13.16 | 14.66 | 15.21 |

TABLE 8 (b)
Reflection Spectra of an Assembly of a TN Cell and a
Cholesteric LC layer for Various Voltages Applied

U_{appl.}/V

| | | | | | |
|---|---|---|---|---|---|
| 0.0 | 1.0 | 2.0 | 3.0 | 4.0 | 5.0 |

| | |
|---|---|
| λ/nm | Intensity of Reflection W/10⁻³ (sr · m² · nm) |

| | | | | | | |
|---|---|---|---|---|---|---|
| 430 | 0.150 | 0.149 | 0.154 | 0.207 | 0.275 | 0.318 |
| 435 | 0.174 | 0.173 | 0.179 | 0.244 | 0.323 | 0.370 |
| 440 | 0.203 | 0.202 | 0.208 | 0.280 | 0.373 | 0.431 |
| 445 | 0.227 | 0.225 | 0.234 | 0.320 | 0.423 | 0.485 |
| 450 | 0.256 | 0.254 | 0.264 | 0.352 | 0.467 | 0.543 |
| 455 | 0.285 | 0.283 | 0.295 | 0.403 | 0.532 | 0.612 |
| 460 | 0.324 | 0.322 | 0.336 | 0.459 | 0.602 | 0.696 |
| 465 | 0.356 | 0.354 | 0.373 | 0.525 | 0.689 | 0.786 |
| 470 | 0.389 | 0.387 | 0.409 | 0.568 | 0.723 | 0.825 |
| 475 | 0.394 | 0.390 | 0.416 | 0.568 | 0.728 | 0.828 |
| 480 | 0.404 | 0.402 | 0.426 | 0.557 | 0.689 | 0.778 |
| 485 | 0.403 | 0.401 | 0.424 | 0.533 | 0.664 | 0.755 |
| 490 | 0.417 | 0.414 | 0.439 | 0.543 | 0.662 | 0.741 |
| 495 | 0.450 | 0.447 | 0.474 | 0.577 | 0.694 | 0.777 |
| 500 | 0.504 | 0.501 | 0.536 | 0.671 | 0.805 | 0.885 |

### Example 3

Similar to the investigations described in example 2, both the transmission through and the and reflection from the cholesteric LC layer is tuned using a liquid crystal cell comprising the liquid crystal in a vertical alignment (VA). The mixture MLC-6609 doped with 3% F357 is injected into the VA cell, a cell of type (3), which has patterned ITO electrode covered with polyimide inducing homeotropic alignment, which is treated with anti-parallel rubbing (which gives vertical alignment state), and has a cell gap of 6 μm. This cell is placed on the cholesteric liquid crystal layer fabricated in example 2, whose optical properties are shown in Tables 8 (a) and (b). The electro-optical properties of the combined cell structure are measured using luminance meter, CS-1000 (Konica Minolta Holdings, Inc., Japan), too. For excitation again an LED having a wavelength of 400 nm is used, as described above.

The spectra in transmission and in reflection, for the cell of type (3) (i.e. the VA cell), comprising the mixture MLC-6609 doped with the dye, is placed in front of the cholesteric liquid crystal cell, are shown in Table 9 (a) for the transmission spectra and in Table 9 (b) for the reflection spectra. It is obvious that upon application of an appropriate voltage both the transmission and the reflection decrease and both the transmission and the reflection can be tuned by a liquid crystal cell comprising a liquid crystal doped with a dye, regardless of the mode of operation of the liquid crystal cell.

These examples clearly show that the cholesteric liquid crystal layer does work as an excellent reflector for light and/or as an emitter of light, and that the intensity of the light may be effectively controlled using any light controlling layer.

TABLE 9 (a)
Emission Spectra of an Assembly of a VA Cell and a
Cholesteric LC layer for Various Voltages Applied

U_{appl.}/V

| | | | | | |
|---|---|---|---|---|---|
| 0.0 | 1.0 | 2.0 | 3.0 | 4.0 | 5.0 |

| | |
|---|---|
| λ/nm | Intensity of Emission W/10⁻³ (sr · m² · nm) |

| | | | | | | |
|---|---|---|---|---|---|---|
| 430 | 29.94 | 29.75 | 29.84 | 20.02 | 16.690 | 16.140 |
| 435 | 23.30 | 23.21 | 23.15 | 15.63 | 12.880 | 12.310 |
| 440 | 21.29 | 21.18 | 20.95 | 14.08 | 11.500 | 11.050 |
| 445 | 18.53 | 18.42 | 18.21 | 12.17 | 10.010 | 9.426 |
| 450 | 18.09 | 18.05 | 17.89 | 11.78 | 9.555 | 9.161 |
| 455 | 17.99 | 17.80 | 17.55 | 11.70 | 9.484 | 8.990 |
| 460 | 19.14 | 19.02 | 18.75 | 12.78 | 10.220 | 9.780 |
| 465 | 19.94 | 19.80 | 19.65 | 13.70 | 10.970 | 10.420 |
| 470 | 19.87 | 19.79 | 19.51 | 14.01 | 11.180 | 10.550 |
| 475 | 20.09 | 19.81 | 19.69 | 14.21 | 11.310 | 10.710 |
| 480 | 18.35 | 18.26 | 18.03 | 13.41 | 10.590 | 9.904 |
| 485 | 18.00 | 18.01 | 17.86 | 13.19 | 10.630 | 9.873 |
| 490 | 17.26 | 17.04 | 16.90 | 12.99 | 10.440 | 9.720 |
| 495 | 16.37 | 16.25 | 16.17 | 12.94 | 10.480 | 9.613 |
| 500 | 16.58 | 16.51 | 16.45 | 13.20 | 11.040 | 10.230 |

TABLE 9 (b)
Reflection Spectra of an Assembly of a VA Cell and a
Cholesteric LC layer for Various Voltages Applied

U_{appl.}/V

| | | | | | |
|---|---|---|---|---|---|
| 0.0 | 1.0 | 2.0 | 3.0 | 4.0 | 5.0 |

| | |
|---|---|
| λ/nm | Intensity of Reflection W/10⁻³ (sr · m² · nm) |

| | | | | | | |
|---|---|---|---|---|---|---|
| 430 | 0.871 | 0.869 | 0.878 | 0.482 | 0.297 | 0.264 |
| 435 | 0.980 | 0.978 | 0.988 | 0.546 | 0.332 | 0.293 |
| 440 | 1.159 | 1.157 | 1.167 | 0.636 | 0.384 | 0.338 |
| 445 | 1.250 | 1.248 | 1.261 | 0.686 | 0.408 | 0.359 |
| 450 | 1.420 | 1.418 | 1.432 | 0.768 | 0.451 | 0.395 |
| 455 | 1.547 | 1.546 | 1.559 | 0.839 | 0.487 | 0.424 |
| 460 | 1.714 | 1.713 | 1.730 | 0.957 | 0.543 | 0.467 |
| 465 | 1.825 | 1.824 | 1.843 | 1.045 | 0.599 | 0.510 |
| 470 | 1.799 | 1.800 | 1.817 | 1.083 | 0.627 | 0.531 |
| 475 | 1.719 | 1.721 | 1.738 | 1.062 | 0.638 | 0.543 |
| 480 | 1.517 | 1.520 | 1.535 | 0.972 | 0.605 | 0.523 |
| 485 | 1.409 | 1.412 | 1.427 | 0.936 | 0.606 | 0.529 |
| 490 | 1.317 | 1.322 | 1.335 | 0.913 | 0.617 | 0.542 |
| 495 | 1.296 | 1.302 | 1.315 | 0.950 | 0.664 | 0.588 |
| 500 | 1.393 | 1.400 | 1.414 | 1.072 | 0.779 | 0.691 |

### Example 4

Six cholesteric liquid crystal layers are prepared as described under example 1 and the reflection properties of a single layer for each colour are determined in comparison to double layers consisting of one layer each with right-handed twisting sense and one layer each having left-handed twisting sense for each of the three colours. The right-handed and the left-handed layers for one colour are identical to each other except for the chiral dopants used being optically opposite to each other, i.e. enantiomers of one another, and, thus, the layers the same magnitude of the cholesteric pitch but mutually opposite sense of twist.

The measurements are performed as described under example 1 using a luminance meter, CS-1000 (Konica Minolta Holdings, Inc., Japan). In a first set of experiments, for example 4a, an incandescent lamp, Fiber Lite Model 190 from Dolan-Jenner Industries, Inc. is used as a light source. The incident light is tilted by an angle of 30° from the direction vertical to the substrate and the reflection is detected in the direction vertical to the substrate. The distance between the light source and the cholesteric liquid crystal layer is 15 cm. Alternatively in a second set of measurements, for example 4b, a white LED (MDBL-CW25) from Dynatec Co.^{Ltd} is used as a light source here too. The intensity of the illumination is measured using a spectroradiometer USHIO type USR-40D-13 from Ushio Inc.

The intensity of illumination of the incandescent lamp and of the white LED are measured at a distance of 15 cm to be 352 μW/cm² and 43.8 μW/cm², respectively. The illumination spectrum of the incandescent lamp and of the white LED is shown in Tables 10 and 11, respectively.

TABLE 10
Illumination Intensity of Incandescent Lamp

| λ/nm | I/μW/cm² · nm |
|---|---|
| 200 | 0.00 |
| 220 | 0.00 |
| 250 | 0.00 |
| 280 | 0.00 |
| 300 | 0.00 |
| 350 | 0.00 |
| 400 | 0.09 |
| 420 | 0.19 |
| 450 | 0.35 |
| 480 | 0.52 |
| 500 | 0.60 |
| 520 | 0.76 |
| 550 | 1.00 |
| 580 | 1.26 |
| 600 | 1.37 |
| 620 | 1.48 |
| 650 | 1.61 |
| 680 | 1.59 |
| 700 | 1.35 |
| 720 | 0.92 |
| 750 | 0.52 |
| 780 | 0.33 |
| 800 | 0.27 |

TABLE 11
Illumination Intensity of White LED

| λ/nm | I/μW/cm² · nm |
|---|---|
| 200 | 0.00 |
| 220 | 0.00 |
| 250 | 0.00 |
| 280 | 0.00 |
| 300 | 0.00 |
| 350 | 0.00 |
| 400 | 0.00 |
| 420 | 0.01 |
| 450 | 0.31 |
| 480 | 0.13 |
| 500 | 0.08 |
| 520 | 0.14 |
| 550 | 0.21 |
| 580 | 0.20 |
| 600 | 0.18 |
| 620 | 0.15 |
| 650 | 0.10 |
| 680 | 0.06 |
| 700 | 0.04 |
| 720 | 0.03 |
| 750 | 0.01 |
| 780 | 0.01 |
| 800 | 0.01 |

### Example 4a

The intensities of reflection of the single layer cholesteric liquid crystal layers (right-handed twist sense) and of double layers cholesteric liquid crystal layers are compared for each of the three colour (R,G,B) under illumination with the incandescent lamp in Table 12.

TABLE 12
Intensity of Reflection of Single Layer and Double Layer
Cholesteric Films under Illumination with Incandescent Lamp

| | Colour | | | | | |
|---|---|---|---|---|---|---|
| | Blue | Green | Red | Blue | Green | Red |
| | Type | | | | | |
| | Single Layer* | | | Double Layer | | |
| | Dye | | | | | |
| | Without Dye | | | | | |
| λ/nm | Intensity of Reflection W/10⁻³ (sr · m² · nm) | | | | | |
| 380 | 0.0485 | 0.0446 | 0.0379 | 0.182 | 0.100 | 0.0362 |
| 400 | 0.268 | 0.246 | 0.194 | 0.961 | 0.545 | 0.201 |
| 420 | 0.675 | 0.570 | 0.445 | 2.46 | 1.35 | 0.467 |
| 450 | 1.95 | 1.28 | 0.777 | 4.99 | 2.86 | 0.822 |
| 480 | 4.32 | 3.68 | 1.16 | 7.40 | 8.08 | 1.25 |
| 500 | 4.97 | 4.86 | 1.38 | 6.80 | 11.4 | 1.51 |
| 520 | 3.09 | 5.72 | 1.74 | 5.74 | 13.3 | 1.96 |
| 550 | 1.83 | 3.08 | 2.50 | 2.27 | 5.89 | 2.89 |
| 580 | 1.92 | 2.12 | 3.33 | 2.06 | 2.65 | 4.53 |
| 600 | 2.05 | 2.14 | 6.11 | 2.13 | 2.42 | 8.58 |
| 620 | 2.16 | 2.22 | 8.24 | 2.23 | 2.45 | 12.9 |
| 650 | 2.39 | 2.43 | 7.81 | 2.44 | 2.60 | 13.7 |
| 680 | 2.45 | 2.49 | 5.26 | 2.47 | 2.64 | 7.16 |
| 700 | 2.14 | 2.13 | 3.18 | 2.14 | 2.29 | 3.71 |
| 720 | 1.48 | 1.48 | 1.79 | 1.49 | 1.56 | 1.92 |
| 740 | 0.939 | 0.958 | 1.08 | 0.949 | 1.02 | 1.16 |
| 750 | 0.801 | 0.822 | 0.913 | 0.828 | 0.878 | 0.978 |
| 760 | 0.707 | 0.705 | 0.794 | 0.720 | 0.759 | 0.881 |
| 780 | 0.526 | 0.540 | 0.613 | 0.531 | 0.572 | 0.679 |

Remarks:
*right-handed twisting sense.

The data compiled in Table 12 clearly show that for all the colours the double layers lead to higher intensities of reflection compared to single layers. Since the overall intensity of reflection is determined as the integral over the wavelength region of the reflection for to each colour, the overall intensity of reflection intensity for the double layer structures is almost two times that of the value for the single layer structures. This fact shows the advantage of the double layer structure for devices to be used in e-paper applications, in which non-polarized light may be utilized.

### Example 4b

The sample layers from the previous example, example 5, are investigated again. Now, however, a white LED (having the emission spectrum shown in Table 11 under Example 4) is used as the light source instead of the incandescent lamp used in example 4a. The results are shown in Table 13.

TABLE 13
Intensity of Reflection of Single Layer Cholesteric Films without
Dye and Double Layer Cholesteric Films with Dye under Illumination
with a White LED

| | Colour | | | | | |
|---|---|---|---|---|---|---|
| | Blue | Green | Red | Blue | Green | Red |
| | Type | | | | | |
| | Single Layer* | | | Double Layer | | |
| | Dye | | | | | |
| | Without Dye | | | | | |
| λ/nm | Intensity of Reflection W/10⁻³ (sr · m² · nm) | | | | | |
| 380 | 0.00009 | 0.00002 | 0 | 0.00093 | 0.00002 | 0 |
| 400 | 0 | 0 | 0 | 0.00003 | 0.00001 | 0 |
| 420 | 0.0221 | 0.0171 | 0.0135 | 0.0982 | 0.0471 | 0.0197 |
| 450 | 0.119 | 0.787 | 0.450 | 0.00346 | 0.00196 | 0.670 |
| 480 | 0.669 | 0.588 | 0.184 | 0.00129 | 0.00146 | 0.284 |
| 500 | 0.438 | 0.437 | 0.125 | 0.666 | 0.00117 | 0.193 |
| 520 | 0.374 | 0.740 | 0.215 | 0.750 | 0.002 | 0.347 |
| 550 | 0.230 | 0.410 | 0.318 | 0.340 | 0.960 | 0.529 |
| 580 | 0.188 | 0.228 | 0.345 | 0.259 | 0.359 | 0.667 |
| 600 | 0.158 | 0.182 | 0.453 | 0.217 | 0.271 | 0.906 |
| 620 | 0.126 | 0.143 | 0.414 | 0.172 | 0.209 | 1.03 |
| 650 | 0.0828 | 0.0935 | 0.260 | 0.114 | 0.134 | 0.593 |
| 680 | 0.0474 | 0.0537 | 0.106 | 0.0653 | 0.0776 | 0.166 |
| 700 | 0.0313 | 0.0351 | 0.0511 | 0.0432 | 0.0513 | 0.0723 |
| 720 | 0.0205 | 0.0231 | 0.0281 | 0.0286 | 0.0339 | 0.0395 |
| 750 | 0.0117 | 0.0138 | 0.0154 | 0.0170 | 0.0197 | 0.0229 |
| 780 | 0.0072 | 0.00827 | 0.0105 | 0.0130 | 0.0130 | 0.0181 |

Remarks:
*right-handed twisting sense.

It is obvious from these results that the double layers lead to an intensity of reflected light of about two times the value for the single layers also under illumination with white LEDs.

### Example 5

As described in Example 1 again a three sets of cholesteric liquid crystal layers reflecting one each of the three colours red, green and blue are prepared. Now, however a total of eight of these cholesteric liquid crystal layers are fabricated, three each for green colour and for red colour and two for blue colour. For each one of the two colours green and red one layer having right-handed helical twisting sense is prepared. And further for each one of these two colours two more layers are prepared, one each with right-handed and with left-handed helical twisting sense. However, in contrast to the layers of example 1, here in each of these four additional cholesteric layers, i.e. two per colour, a fluorescent dye is incorporated into the cholesteric layer. For the two cholesteric liquid crystal layers giving green selective reflection 2.16% of the green dye coumarin 6 commercially available from Aldrich relative to the amount of the total mass of the resultant mixture are incorporated. For the two cholesteric liquid crystal layers giving red selective reflection 0.2% coumarin 6 and 0.26% of NK-3590 commercially available from Hayashibara Biochemical Laboratories, Japan relative to the amount of the total mass of the resultant mixture are incorporated. The layers with mutually opposite twisting sense, incorporating the respective dye/dyes are combined into a double layer for each colour.

At last, two cholesteric liquid crystal layers, which reflect blue light are prepared for this example. They have mutually opposite twisting sense to each other. One of these layers, the one with right haded twisting sense, is investigates as is a single layer and then both are combined into a double layer and investigated again. These latter two blue layers do not contain any dye molecules.

### Example 5a

These six layers, three single layers and three double layers, are investigated using an incandescent lamp as described under example 4a and the intensities of reflection for the single layers (having right-handed twisting sense) are compared to those of the respective double layers, those for green and red incorporating dyes. In table 14 the intensities of reflection for the single layers without dyes are compared to those of double layers.

TABLE 14
Intensity of Reflection of Single Layer Cholesteric Films without Dye
and Double Layer Cholesteric Films with Dye under Illumination with
Incandescent Lamp

| | Colour | | | | | |
|---|---|---|---|---|---|---|
| | Blue | Green | Red | Blue | Green | Red |
| | Type | | | | | |
| | Single Layer* | | | Double Layer | | |
| | Dye | | | | | |
| | Without Dye | | | | With Dye | |
| λ/nm | Intensity of Reflection W/10⁻³ (sr · m² · nm) | | | | | |
| 380 | 0.0485 | 0.0446 | 0.0379 | 0.182 | 0.0919 | 0.0060 |
| 400 | 0.268 | 0.246 | 0.194 | 0.961 | 0.389 | 0.0295 |
| 420 | 0.675 | 0.570 | 0.445 | 2.46 | 0.754 | 0.0966 |
| 450 | 1.95 | 1.28 | 0.777 | 4.99 | 1.25 | 0.274 |
| 480 | 4.32 | 3.68 | 1.16 | 7.40 | 2.67 | 0.512 |
| 500 | 4.97 | 4.86 | 1.38 | 6.80 | 3.98 | 0.637 |
| 520 | 3.09 | 5.72 | 1.74 | 5.74 | 12.6 | 0.893 |
| 550 | 1.83 | 3.08 | 2.50 | 2.27 | 12.3 | 1.75 |
| 580 | 1.92 | 2.12 | 3.33 | 2.06 | 4.16 | 6.71 |
| 600 | 2.05 | 2.14 | 6.11 | 2.13 | 3.05 | 14.6 |
| 620 | 2.16 | 2.22 | 8.24 | 2.23 | 2.70 | 25.5 |
| 650 | 2.39 | 2.43 | 7.81 | 2.44 | 2.60 | 32.5 |
| 680 | 2.45 | 2.49 | 5.26 | 2.47 | 2.54 | 22.1 |
| 700 | 2.14 | 2.13 | 3.18 | 2.14 | 2.20 | 11.9 |
| 720 | 1.48 | 1.48 | 1.79 | 1.49 | 1.49 | 4.51 |
| 750 | 0.801 | 0.822 | 0.913 | 0.828 | 0.846 | 1.66 |
| 780 | 0.526 | 0.540 | 0.613 | 0.531 | 0.562 | 1.07 |

Remarks:
*right-handed twisting sense.

The data compiled in Table 14 clearly show the enormous effect of incorporation of a dye into the cholesteric layer on the intensity of the reflected light. In particular for the film reflecting in the red spectral region the peak of the intensity of the reflection for double layers containing dyes is three times that of the single layer without dyes. This may be explained by the contribution of the light having a shorter wavelength being utilized due to effect of the dye molecules converting the wavelength of the light. Otherwise this light having a shorter wavelength does not contribute to the reflection is. Thus, it is obvious that the intensity of reflected light is significantly enhanced by the incorporation of a dye into the cholesteric layer in addition to the enhancement resulting from the use of double layers instead of single layers.

### Example 5b

These very six layers are investigated again. But here, like in example 4b, a white LED is used as light source instead of the incandescent lamp. The intensities of reflection for the single layers (having right-handed twisting sense) are compared to those of the respective double layers, those for green and red incorporating dyes in table 15.

TABLE 15
Intensity of Reflection of Single Layer Cholesteric Films without
Dye and Double Layer Cholesteric Films with Dye under Illumination
with a White LCD

| | Colour | | | | | |
|---|---|---|---|---|---|---|
| | Blue | Green | Red | Blue | Green | Red |
| | Type | | | | | |
| | Single Layer* | | | Double Layer | | |
| | Dye | | | | | |
| | Without Dye | | | | With Dye | |
| λ/nm | Intensity of Reflection W/10⁻³ (sr · m² · nm) | | | | | |
| 380 | 0.00009 | 0.00018 | 0 | 0.00093 | 0.00002 | 0.00004 |
| 400 | 0 | 0 | 0 | 0.00004 | 0.00005 | 0 |
| 420 | 0.0221 | 0.0171 | 0.0135 | 0.0982 | 0.0289 | 0.00024 |
| 450 | 1.19 | 0.787 | 0.450 | 3.46 | 0.797 | 0.0923 |
| 480 | 0.669 | 0.588 | 0.184 | 1.29 | 0.465 | 0.0448 |
| 500 | 0.438 | 0.437 | 0.125 | 0.666 | 0.493 | 0.0301 |
| 520 | 0.374 | 0.740 | 0.215 | 0.750 | 2.27 | 0.0563 |
| 550 | 0.230 | 0.410 | 0.318 | 0.340 | 2.52 | 0.127 |
| 580 | 0.188 | 0.228 | 0.345 | 0.259 | 0.730 | 0.493 |
| 600 | 0.158 | 0.182 | 0.453 | 0.217 | 0.438 | 1.11 |
| 620 | 0.126 | 0.143 | 0.414 | 0.172 | 0.293 | 1.85 |
| 650 | 0.0828 | 0.0935 | 0.260 | 0.114 | 0.165 | 1.85 |
| 680 | 0.0474 | 0.0537 | 0.106 | 0.0653 | 0.0918 | 0.941 |
| 700 | 0.0313 | 0.0351 | 0.0511 | 0.0432 | 0.0597 | 0.442 |
| 720 | 0.0205 | 0.0231 | 0.0281 | 0.0286 | 0.0393 | 0.197 |
| 750 | 0.0117 | 0.0138 | 0.0154 | 0.0170 | 0.0230 | 0.0786 |
| 780 | 0.0072 | 0.00088 | 0.0105 | 0.0130 | 0.0145 | 0.0466 |

Remarks:
*right-handed twisting sense.

These data clearly shown that the effect of the incorporation of a dye into the cholesteric layer is significantly improving the intensity of light reflected also for illumination with a white LED.

### SHORT DESCRIPTION OF THE FIGURES

1. FIG. 1

Schematic illustration of the embodiment of the instant invention using a layer of twisted nematic liquid crystal doped with a dichroic dye as the electro-optical switching element.

a) Twisted nematic state without applied electric voltage.

b) With applied electric voltage.

2. FIG. 2

Schematic illustration of the embodiment modified from that of FIG. 1 by the additional use of a back light.

a) Twisted nematic state without applied electric voltage.

b) With applied electric voltage.

3. FIG. 3

Schematic illustration of the embodiment of the instant invention using an electrophoretic cell as the electro-optical switching element.

a) Electric DC voltage applied so that the lower electrode has a charge with the opposite sign charge relative to that of the particles.

b) Electric DC voltage applied so that the lower electrode has a charge with the same sing as that of the particles.

4. FIG. 4

Schematic illustration of the embodiment modified from that of FIG. 3 by the additional use of a back light.

a) DC voltage applied, so that the lower electrode has a charge with the opposite sign of that of the charge of the particles.

b) DC voltage applied, so that the lower electrode has a charge with the same sign as that of the charge of the particles.

5. FIG. 5

Schematic illustration of the fifth embodiment of the instant invention, using a layer of a composite of a liquid crystal with a low molecular weight and of a polymer as the electro-optical switching element.

a) State without applied electric voltage.

b) With applied electric voltage.

6. FIG. 6

Schematic illustration of the sixth embodiment of the instant invention, using an electro-gyric electro-optical switching element.

a) DC voltage applied, so that the lower electrode has a charge with the opposite sing of the charge of the black part of the spherical particles.

b) Electric DC voltage, applied so that the lower electrode has a charge with the same sing as the charge of the black part of the spherical particles.

7. FIG. 7

Schematic illustration of the embodiment, in which the material comprising the light emitting moiety is (resp. moieties are) is embedded in an additional layer.

8. FIG. 8

Schematic illustration of the embodiment, in which the layer reflecting the exciting light is placed on the layer emitting light.

### EXPLANATION OF SYMBOLS FOR THE FIGURES

### I. General Remarks

### 1. Division of Parts a and b of the Figures

In the respective first parts of the individual figures (i.e. the parts labelled “a”) the non-switched state, respectively the more strongly absorbing state, respectively the state with the lower transmission of the electro-optical switching element(s) is shown. The respective second parts of the figures (i.e. the parts labelled “b”) show the respective complementary state. For simplicity in FIGS. 1b, 2b, 3a and 3b a single, exemplary electro-optical switching element is shown only. FIGS. 1a, 2a, 4a, 4b, 5a and 5b three switching elements, one each for each colour (R, G, B) are shown.

### 2. Path of Light

Broad arrows in the figures indicate the path of light.

### 3. Colour of Light

R red,

B blue and

G green.

### II. Reference Numbers

### 1. FIGS. 1a and 1b:

101 dichroic dye
102 liquid crystal molecule
103 electrodes
104 TFT
105 cholesteric liquid crystal
106 incident light
107 reflected light

### 2. FIGS. 2a and 2b:

201 dichroic dye
202 liquid crystal molecule
203 electrodes
204 TFT
205 cholesteric liquid crystal
206 incident light
207 material comprising one or more light emitting moieties
208 light from back light

### 3. FIGS. 3a and 3b:

301 charged particles
302 fluid medium
303 electrodes
304 TFT
305 cholesteric liquid crystal
306 incident light
307 material comprising one or more light emitting moieties
312 frame of cell of switching element

### 4. FIGS. 4a and 4b:

401 charged particles
402 fluid medium
403 electrodes
404 TFT
405 cholesteric liquid crystal
406 incident light
407 material comprising one or more light emitting moieties
408 back light with light coming from back light
409 dielectric shield
410 reflected light
411 converted light from back light
412 frame of cell of switching element

### 5. FIGS. 5a and 5b:

501 polymer material
502 low molecular weight liquid crystal
503 electrodes
504 TFT
505 cholesteric liquid crystal
506 incident light

### 6. FIGS. 6a and 6b:

601 twist ball
602 electrophoretic medium
603 electrode
604 thin film transistor (switching element)
605 cholesteric liquid crystal layer
606 ambient light
607 reflected light from the cholesteric liquid crystal layer
613 black half sphere of the twist ball

### 7. FIG. 7:

701 light emitting layer
702 cholesteric liquid crystal layer
703 exciting light
704 emitted light from the light emitting moiety

### 8. FIG. 8:

801 light emitting layer
802 cholesteric liquid crystal layer
803 exciting light
804 emitted light from the light emitting moiety
805 exciting light reflecting layer

1. An electro-optical switching element comprising
one or more layers of cholesteric liquid crystal, capable
to selectively reflect (visible) light and
an electro-optical element, which is capable
to control the intensity of light.

2. An electro-optical switching element according to claim 1 comprising
one or more layers of cholesteric liquid crystal, capable
to selectively reflect (visible) light
to shift the wavelength of (the) light to longer values and
an electro-optical element, which is capable
to control the intensity of light.

3. An electro-optical switching element according to claim 1
comprising
one or more layers of cholesteric liquid crystal, capable to selectively reflect (visible) light and
one or more other layers capable
to shift the wavelength of (the) light to longer values and
an electro-optical element, which is capable
to control the intensity (transmission/reflection/scattering) of light.

4. An electro-optical switching element according to claim 1, comprising
a means for illumination (as e.g. a backlight).

5. An electro-optical switching element according to claim 1, comprising a means for selectively reflecting excitation light.

6. An electro-optical switching element according to claim 5, comprising a means for selectively reflecting excitation light, said means for selectively reflecting excitation light comprising a cholesteric liquid crystal material.

7. An electro-optical switching element according to claim 1, in which the electro-optical element that is capable to control the intensity of light comprises a liquid crystal material.

8. An electro-optical switching element according to claim 7, in which the electro-optical element comprises a liquid crystal switching selected from the following group of liquid crystal switching elements
a liquid crystal comprising one or more dichroic dyes,
a composite of a liquid crystal comprising a component having a low molecular weight and a polymer component (like e.g. a PDLC, NCAP or PN) and
a phase change liquid crystal material (like e.g. a S_{A} phase change material or a cholesteric phase change material).

9. An electro-optical switching element according to claim 1, in which the electro-optical element that is capable to control the intensity of light is an electrophoretic switching element.

10. An electro-optical switching element according to claim 1, in which the electro-optical element that is capable to control the intensity of light is an electro-gyric switching element.

11. An array of electro-optical switching elements according to claim 10, wherein the light conversion means is a layer of laminated layers or films.

12. An array of electro-optical switching elements according to claim 10, wherein the light conversion means has the form of a spatially structured/patterned layer having separate areas for the three colours red, green and blue, respectively.

13. An electro-optical display comprising an array of electro-optical switching elements according to claim 11.

14. A display according to claim 13, characterized in that it is comprises an array active matrix, e.g. a matrix of TFTs capable of addressing the display.

15. An electro-optical display comprising an electro-optical switching element according to claim 1.

16. An electro-optical display comprising an array of electro-optical switching elements according to claim 11.

17. An electro-optical display of claim 15 for the display of information.

18. An electro-optical display of claim 16 for the display of information.
